(19) United States
(12) Patent Application Publication
(10) Pub. No.: US 2008/0285652 A1
(43) Pub. Date: Nov. 20, 2008

(54) Apparatus and methods for optimization of image and motion picture memory access

(75) Inventors: Gedalia Oxman, Tel-Aviv (IL); Gregory Chernov, Herzlia (IL)

Correspondence Address: MARTIN D. MOYNIHAN d/b/a PRTSI, INC., P.O. BOX 16446, ARLINGTON, VA, 22215, US

(73) Assignee: Horizon Semiconductors Ltd., Herzlia (IL)

(21) Appl. No.: 11/798,411

(22) Filed: May 14, 2007

(51) Int. Cl. H04B 1/66

(52) U.S. Cl. 375/240.16; 375/E07.105

(57) ABSTRACT

A cache memory device for location between a main memory and a requesting processor is disclosed. The main memory stores memory blocks, some of which are temporarily located in the cache memory device to improve retrieval performance. The cache memory device is configured to receive requests for respective memory blocks, and the cache memory device comprises an input pooling unit for pooling incoming requests for blocks of memory as well as a request selection mechanism configured for selecting amongst those pooled requests. The request selection mechanism operates according to one or more optimization criteria to optimize the operation of the cache memory device. The device is particularly useful for image and video compression.

### FIELD AND BACKGROUND OF THE INVENTION

The present invention relates to the optimization of access to computer memory, including methods thereto relating as well as a cache memory device and methods for its use. The cache memory device is suited for memory-intensive applications, such as, but not exclusively, those involved in image and motion picture processing. Image processing applications include processing motion picture streams (including high definition video) to facilitate real-time processing tasks such as, but not exclusively, motion estimation, compression, and decompression. Similar procedures are used in other applications that involve searching for data correlation between images or 2-dimensional arrays, for example: image recognition, robotic vision, still image data compression and so on. All of these applications are characterized by their need to repeatedly access large amounts of data stored in a main memory subsystem.

As is well-known, memory-intensive computing operations can be accelerated through the judicious use of faster, generally more costly, cache memory devices. Such cache memory devices store temporary copies of portions of a main memory subsystem and can transmit those copies to a requesting client processor. This provides faster access to the required data stored in that memory if it is present in the cache memory due to a prior reference or a pre-fetch issued in anticipation of the request.

Image processing in general, and digital motion picture processing specifically, represents a class of computing applications that require a huge amount of memory bandwidth. In various video applications, such as video cameras, television, set top boxes, and DVD's, video frame rate and resolution is steadily increasing to improve video quality and the viewer experience. This results in an increasing burden on video processing circuits involved in the acquisition, transmission and playback of video.

To cope with increasing video frame rate and resolution, video compression schemes, such as those defined by the MPEG and MPEG4 Part 10 (also called H.264 or AVC) industry standards, are typically employed to reduce the video bit rate and corresponding storage and transmission bandwidth requirements. Naturally, this requires compression prior to transmission or storage and decompression prior to use or display.

In certain parts of the video processing chain, however, the processing circuits must work with the uncompressed video samples. This is the case, for example, in the compression circuit itself, which must receive video in uncompressed form and convert it into a compressed form. Similarly, the video decompression circuit performs the opposite task, namely decoding the compressed video to uncompressed form, for example for display or transcoding. Thus, these image processing tasks are typical of those requiring very high data throughput and memory bandwidth.

One common method used in the art in motion picture compression schemes is to encode temporal redundancy (i.e., information shared among two or more frames) through motion estimation (and its counterpart in decompression, motion compensation). In motion estimation, one must search for similarities between rectangular portions of different frames within a motion picture sequence. Starting with a frame to be encoded (the “current frame” or CF) and a specific rectangular region (the “current block” or CB), one must identify a sufficiently similar region (the “reference block” or RB) in another frame (the “reference frame” or RF). The encoding (i.e., compression) entails recording the horizontal and vertical displacement of the CB from the RB as a motion vector and a representation of the differences between the CB and RB. Motion compensation reverses this process to reconstruct the original picture.

Typically in the motion estimation process, the CF is divided into a grid of rectangular areas called macroblocks (for example, the MPEG standard specifies a square area, 16 pixels by 16 pixels). Then, for each macroblock of the CF, a search is made on past and future frames, to find similar areas that can be used as a reference to efficiently encode the current macroblock.

Each candidate RB is brought into the processing circuit, and compared to the current macroblock using an error measurement cost function (for example, the sum of absolute differences (SAD) is commonly used). Potential candidates are those that fall below an arbitrarily determined error or cost threshold. The motion estimation process then chooses the best candidate among a potentially large group of contenders.

This type of search used in motion estimation is one example in which large amounts of video storage and memory bandwidth are required. During the search processing of a single macroblock, many candidate RBs must be transferred into the motion estimation processing circuit from external video frame storage memories.

Other examples of image processing that require repeated access to image data include intra-frame compression, image enhancement, image recognition, robotic vision, and indeed any processes that require access to many pixels to generate one or more output pixels. Similarly, many other applications outside the realm of image processing require access to large amounts of memory to perform their tasks.

The art has been employing simple cache devices to reduce the video memory access bandwidth requirements of the motion estimation circuit. Usually a single rectangular search window (known as a “reference window” or RW) around the co-located position of the current macroblock in a particular reference frame is cached in on-chip memory. U.S. Pat. No. 5,696,698, which is incorporated herein by reference in its entirety, describes such a device for addressing a single rectangular search area cache memory of a motion picture compression circuit. U.S. Pat. No. 7,006,100, which is also incorporated herein by reference in its entirety, notes that it is difficult to use such a device to support two such search areas simultaneously without resorting to the trivial, yet expensive solution of duplicating the cache memory area in its entirety. U.S. Pat. No. 7,006,100 continues to describe an alternative cache device that can be dynamically configured per frame to one of two modes, i.e., to store either two independent rectangular small search areas or a single logical wide rectangular search area.

State of the art video compression standards, such as the H.264 standard, have introduced new requirements. These improve previous standards such as MPEG-II, by allowing the current macroblock to be further sub-divided into smaller sub-blocks, where each sub-block may independently specify a motion vector. Further, advances in multi-frame prediction allow many reference frames to participate in the generation of the reference area of the current macroblock, by allowing each sub-macroblock motion vector to specify a different reference frame. In addition, fine grained sub-pixel interpolation requires more surrounding pixels around each reference macroblock area as compared to older compression standards. These advances exacerbate the memory bandwidth problem, since modern video compression motion estimation must now consider many more candidates to make a good selection, thus increasing memory bandwidth demands.

Duplicating conventional cache devices for a single or two rectangular areas to support a much larger number of areas is prohibitively expensive as well as inefficient. The current art lacks a memory caching device that allows motion estimation or other video processing circuits to load and search many reference candidate areas of arbitrary size and shape, including non-rectangular ones, across many reference frames. Furthermore, current video cache designs are limited to predetermined patterns of size and shape and cannot adapt to the dynamic content of the video stream.

Another limitation of the current art is the need for a cache client (i.e., a processor requesting memory) to wait until a memory request has been fully satisfied before a subsequent one may be handled. This prevents or delays the handling of requests for other regions that may, in fact, already be cached and could be delivered while the missed data is being fetched from main storage.

Current image cache designs are further limited in the way they provide data to the client, in that they are typically optimized, if at all, for either progressive (full-frame) or interlaced image handling, but not both. These issues are particularly pertinent with respect to performing a 3:2 pulldown process. 3:2 (or 2:3) pulldown processing is commonly used in video encoding devices for material that originated in cinema film at 24 frames per second and must be converted into NTSC format at 29.97 frames per second or vice versa. This type of processing is also known as telecine, inverse or reverse telecine, cadence correction, and inverse or reverse pulldown.

Another capability lacking in current cache designs is a mechanism to programmatically adjust the mapping between the main memory's address space and the physical storage used for the cache memory to provide optimal performance depending upon the application.

Another limitation of the current art of memory caches used in image and motion picture processing appears in the problem of access to the cache memory components. Typically such cache devices are single-threaded and do not need to simultaneously access the cache memory for writing data retrieved from the main memory and reading from the cache memory to transmit data to the requesting client. In such a case, less expensive single-port memory components are appropriate. If a cache is to be multithreaded, the current art would specify more expensive dual-port memory components or would have to single-thread internal operations against a bank of single-port memories, compromising the cache device's performance.

Another factor militating against the creation of a multithreaded cache device is the need for a highly efficient control structure to facilitate communication between the various sub-processors working together within the cache device.

While the art cited above provides simple architectural features to optimize caching for macroblocks used in motion estimation, the art lacks a generalized architectural approach that would optimize caches for sub-macroblocks and the more general case of caching two-dimensional data.

There is thus a widely recognized need for, and it would be highly advantageous to have, a cache memory device devoid of the above limitations.

### SUMMARY OF THE INVENTION

According to one aspect of the present invention there is provided a cache memory device for use in an image or motion picture processing system, said cache memory device being located between a main memory and a requesting processor, the main memory storing images, said images having an image width and an image height, said images being divisible into blocks, each block having a block width and a block height being less than or equal to the image width and image height respectively, the cache memory device being configured so as to temporarily locate arbitrary ones of said blocks in said cache memory device thereby to improve retrieval performance.

According to another aspect of the present invention there is provided a cache memory device for use in image or motion picture processing systems, said cache memory device being located between a main memory and a requesting processor, the main memory storing images, each image having an image width and an image height, each said image being divisible into blocks, each block having a block width and a block height being less than or equal to the image width and image height respectively, the requesting processor being configured to issue requests to the cache memory device for arbitrary portions of an image stored in the main memory, said requests having a request width and request height less than the image width and image height respectively, the cache memory device being configured so as to temporarily locate arbitrary ones of said blocks in said cache memory device to improve retrieval performance, and the cache memory device comprising a cache logic circuit engine able to service multiple requests from the requesting processor simultaneously.

According to another aspect of the present invention there is provided a cache memory device for location between a main memory and a requesting processor, the main memory storing memory blocks, some of which are temporarily located in said cache memory device to improve retrieval performance, said cache memory device configured to receive requests for respective ones of said memory blocks, said cache memory device comprising:

an input pooling unit for pooling incoming requests for blocks of memory; and

a request selection and servicing mechanism configured for selecting amongst and servicing requests in said pool for memory block retrieval, said selecting and servicing being according to a first optimization criterion, thereby to optimize operation of said cache.

According to another aspect of the present invention there is provided a method for storing and delivering memory blocks from a memory storage device to a client processor requesting said memory blocks, said memory storage comprising a plurality of independently accessible memory banks, said memory blocks being of a given width and height such that the height comprises one or more successive groups of four rows, each said group having a first, second, third, and fourth row, successively; the method comprising storing the rows within each said group such that the first and fourth rows are stored in one of said plurality of memory banks, and the second and third rows are stored in another of said plurality of memory banks, thereby permitting concurrent transmission of data from any one of the following combinations of rows:

First row and second row, or

Third row and fourth row, or

First row and third row, or

Second row and fourth row.

According to another aspect of the present invention there is provided a cache memory device for location between a main memory and a requesting processor, the main memory storing memory blocks, some of which are temporarily located in said cache memory device to improve retrieval performance, and comprising a plurality of single-port cache memory components for storing respective memory blocks, said cache memory device configured with a controller to select memory blocks for transmission from said cache memory device to the requesting processor according to a first criterion, the first criterion being that writing of data is permitted to a first of said memory components and reading of data simultaneously with said writing is permitted from at least one other of said memory components.

According to another aspect of the present invention there is provided a cache memory device for location between a main memory and a requesting processor, the main memory storing memory blocks, some of which are temporarily located in said cache memory device to improve retrieval performance, said cache memory device configured to receive requests for respective ones of said memory blocks, said cache memory device comprising a content-addressable memory structure for maintaining the state of the cache memory and the relationship between the main memory's address space and the cache memory's address space.

According to another aspect of the present invention there is provided a cache memory device for location between a main memory configured to store an image of a given width W_{image} and height and a requesting processor, the image comprising memory blocks, some of which are temporarily located in said cache memory device to improve retrieval performance, said cache memory device configured to receive requests for respective ones of said memory blocks, said cache memory device comprising a plurality of J sub-caches, each sub-cache comprising cache blocks of a given width W_{cache-block} and height, said W_{cache-block} being less than W_{image}, and the image being logically divided into groups of J vertical stripes, each said vertical stripe being of width W_{cache-block}, and each sub-cache being associated with exactly one vertical stripe of each group of J vertical stripes.

According to another aspect of the present invention there is provided an apparatus for accepting a plurality of memory requests from a requesting processor, also known as a client, and may use various criteria to optimize the performance of the cache.

According to another aspect there is provided an output pooling unit to buffer the results of a plurality of memory requests. Interim results of fetching memory from the main storage are stored in the output pooling unit. When a memory request is fully satisfied and stored in the output pooling mechanism, the results are transmitted to the requesting processor.

According to another aspect of the present invention there is provided a method for storing data within the cache memory, said method permitting simultaneous transmission to the requesting processor of either consecutive rows of memory or alternating rows of memory, according to the request of the requesting processor. Note that the terms “row” or “rows” and “line” or “lines” are used interchangeably when referring to the horizontal portions of a rectangular portion of memory.

According to another aspect of the present invention there is provided an apparatus for using relatively inexpensive, single port memory components as the cache memory storage while supporting simultaneous read and write operations to the overall cache memory by forbidding simultaneous read and write access to an individual component.

According to another aspect of the present invention is provided a Meta-cache Control Block (MCB)—a content-addressable memory structure to maintain state information about the cache memory. The MCB provides a plurality of planes of elements, where each plane corresponds to a single memory request and the elements therein correspond both to portions of the requested memory block and to the cache memory blocks that will hold those portions. The MCB maintains the state of each of the cache memory blocks and the mapping between the main memory address space and the cache memory address space. A further refinement of the address-mapping function incorporates a programmable address-shuffling mechanism to allow fine-tuning and optimization of the mapping from the main memory address space into the cache memory address space.

According to yet a further aspect of the present invention there is provided the use of a plurality of J sub-caches. The main memory stores pictures (e.g., images, frames, fields) and each picture has a width and height. The sub-caches comprise cache blocks of a given width and height less than the width and height respectively of the pictures stored in the main memory. A picture stored in main memory is divided into successive vertical stripes, each of the same width as that of the cache blocks. The vertical stripes are treated as groups of J successive vertical stripes. In each such group, one sub-cache corresponds to one vertical stripe. As portions of the main memory picture are read into the cache, adjacent portions of the main memory will be read into differing sub-caches. Similarly, when transmitting memory from the cache to the requesting processor, horizontally adjacent portions will be read from differing sub-caches.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

It should be appreciated that certain aspects of the invention are not limited to the task of motion estimation in video encoding and can also be applied to the task of block matching or image area correlation for image recognition, robotic vision, still-image data compression, and other applications that may require searching for the best matching block of pixels or data values on a 2-dimensional image or data field. Still other aspects of the invention apply to cache memory devices generally, not limited to a specific application, while other aspects apply to memory access generally, not specifically within the context of systems that use cache memory.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram showing a cache memory device's primary components for pooling and selecting input requests from a requesting processor for memory blocks from a main memory.

FIG. 2 illustrates a method for storing and delivering rectangular memory blocks that permits simultaneous access either to consecutive or to alternate pairs of rows therefrom.

FIG. 3 illustrates a preferred embodiment of a cache memory device using single-port memories with a controller that controls access to allow a write operation to occur to memory simultaneous with read operations on one or more other memories.

FIG. 4 illustrates the Meta-cache Control Block (MCB), according to a preferred embodiment of the present invention.

FIG. 5 provides a simple overview of the use of sub-caches and corresponding groups of vertical stripes in a main memory, according to a preferred embodiment of the present invention.

FIG. 6 illustrates the position of a cache device in a motion estimation system.

FIG. 7 illustrates how current video compression standards allow reference areas to come from several reference frames.

FIG. 8 shows the division of the cache into sub-caches and their relationship to an image stored in main memory, according to a preferred embodiment of the present invention.

FIG. 9 illustrates the mapping from the virtual addresses representing the main memory address space to the cache's address space, including the use of a programmable shuffling network, according to a preferred embodiment of the present invention.

FIG. 10 is a block diagram of the various components of a cache memory device cooperating through the MCB, according to a preferred embodiment of the present invention.

FIG. 11 schematically depicts seven ways in which fields and frames can be combined to service a single client request, according to a preferred embodiment of the present invention.

FIG. 12A illustrates the MCB's structure according to a preferred embodiment of the present invention.

FIG. 12B illustrates operations on the MCB's structure according to a preferred embodiment of the present invention.

FIG. 13 illustrates the lookup engine and lookup pipes, according to a preferred embodiment of the present invention.

### DESCRIPTION OF THE PREFERRED EMBODIMENTS

The present embodiments comprise an apparatus and a method for a high-performance, multi-processing cache memory device. The cache can accept a plurality of requests from a requesting processor client for memory blocks from a main memory. The cache temporarily stores portions of the main memory in the cache memory and transmits the requested memory to the client. The handling of the memory requests is optimized through various means, including pooling of requests and selecting according to various criteria, parallel processing of requests throughout the cache, use of a content-addressable memory structure to maintain state and provide communication between the various cache components, and extensive pipelining of operations within components.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As noted above, the invention addresses the needs of any memory-intensive application. It also includes special constructs in support of memory used to represent two-dimensional objects, such as, but not limited to, pictures and video frames. In the illustrative preferred embodiments described herein, the invention's use in the exemplary application of a video processing system is described, including its use for motion estimation and compensation. It is to be understood that the embodiments for these applications are described for the purpose of better understanding the invention and should not be construed as limiting the invention to these embodiments or applications.

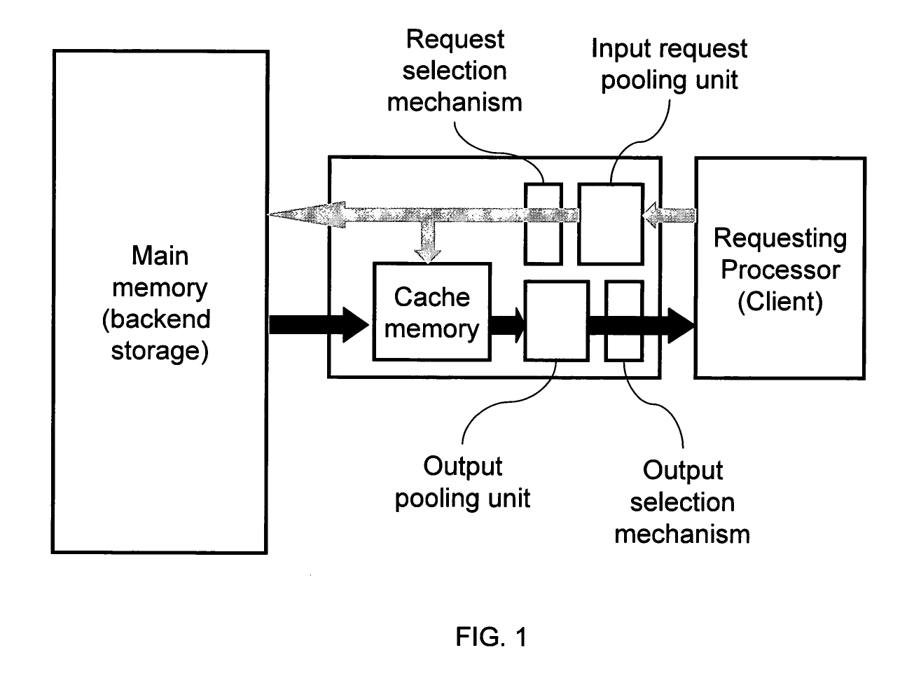

Reference is now made to FIG. 1, which is a block diagram providing a simplified overview of how the cache memory device (or simply, cache) of the present embodiment operates. The cache memory device is located between a requesting client processor (or simply, client) and the main memory. The client issues requests for portions of an image stored in the main memory. The requests are pooled in the illustrated pooling unit and serviced by the cache memory device according to criteria to optimize the cache's operation and performance. The client request is split into smaller blocks. When such a memory block is requested for the first time, the request is passed to the main memory, whence it is retrieved and stored in the cache memory. To satisfy the request, the memory is transferred from the cache memory to the client.

The input pooling unit and controller allow the cache to multithread memory requests. For example, in a preferred embodiment when selecting a pending request from the input pool, the controller may be constructed in such a way that a request for memory that is already in the cache would be serviced rapidly, directly from the cache memory, without waiting behind a request that needs to be serviced from the main memory.

The controller may also be configured to weight priorities according to the time a request was received. As the age increases, the priority for handling the request is increased. This can help ensure that a request is not neglected.

The controller may also be constructed so as to adjust priority for processing when a request in the input pool overlaps a currently active request or another pending request.

Another criterion the controller may use is the location in the main memory of the requested memory block. In some embodiments, performance may be optimized by clustering requests. Other embodiments may assign higher priority to requests that reference differing memory banks.

Similarly, when the requested memory is present in the cache, the location of that memory within the cache memory may be a factor in prioritizing requests for selection.

Among the criteria that may be considered in certain embodiments is the concurrent occurrence of a write operation to a portion of cache memory. For example, selecting a request that does not collide with the write operation can improve the cache performance.

Many other criteria may also be considered when selecting requests from the input pooling unit depending on the embodiment.

In one preferred embodiment, the cache transfers partial results to the client as they become available and the client manages issues related to receiving that partial data. In another preferred embodiment, the cache incorporates an output pooling unit, which serves to buffer the interim partial results of multiple active requests and transfers the results to the client when certain conditions are met and according to certain criteria.

One condition that may be considered is to transfer the results only when the full result of the request is available. Alternatively, results may be transferred only in a given order. For example, the output controller can guarantee that rows of a rectangular memory request will be delivered to the client in order from top to bottom.

When the output pooling unit is divided into sub-units, the output controller can take into account the respective utilization of space in each sub-unit. For example, priority could be given to delivering data from a sub-unit that is the most full, thus freeing up space in that sub-unit for subsequent requests.

In the case where there are sub-units in the output pooling unit, the input selection controller can also consider the utilization of space within the sub-units, giving a higher priority to input requests that will ultimately be handled by output sub-units that are less full.

Additional examples of the operation of the cache with regard to these features and criteria are presented in the ensuing discussions of additional embodiments.

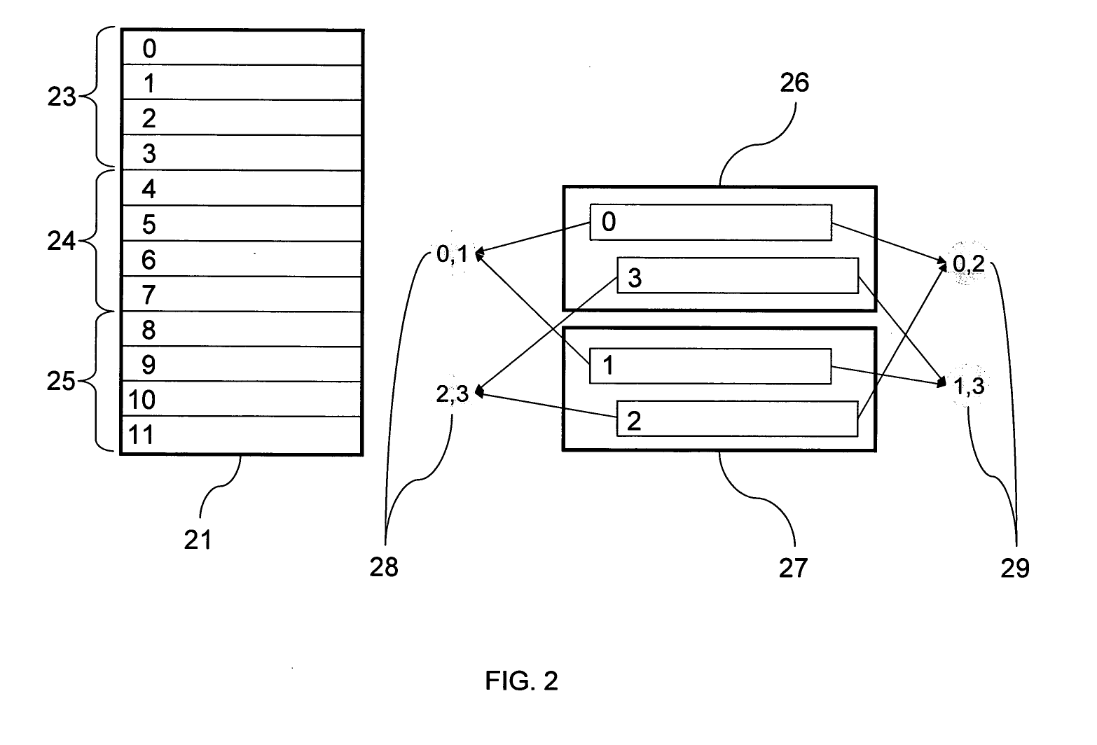

Another aspect of the invention is the storage method shown in FIG. 2. In a preferred embodiment of a video processing system, the video images can be stored in full frame (progressive) format. The video processor may require memory blocks from the memory storage in full frame format, in which case all the rows of the images must be delivered sequentially. There may also be times when the processor requires the odd field or the even field of the image, i.e., alternate lines from the image must be delivered sequentially. One example where these alternate means of accessing the image are required is when performing telecine and inverse telecine.

The storage method shown in FIG. 2 considers groups of four rows within a memory block request 21, such as groups 23, 24, and 25. For each group of four rows, taking group 23 as an example, the first and fourth rows are stored in one memory bank 26 and the second and third rows are stored in a different memory bank 27. When the parameters for the width and depth of the rows are appropriately set within the limits of the memory banks, the use of different memory banks allows a single burst from each bank, said bursts occurring simultaneously, to transmit any of four different combinations of rows. For example, to satisfy requests 28 for consecutive rows, either combination of first row plus second row or third row plus fourth row may be transmitted in parallel from the two memory banks. Similarly, to satisfy requests 29 for one field or the other, either combination of first row plus third row or second row plus fourth row may be transmitted in parallel. It is understood that the same effect can be achieved by placing the rows in more than two memory banks, so long as neither of the first nor fourth rows co-exist in the same memory bank with either of the second or third rows.

This method thus provides improved performance when accessing two dimensional data that may be accessed either in terms of consecutive rows or alternate rows. In both cases the memory can transmit the data in a single cycle. The above examples from video processing are not intended to limit the scope of the invention—this method is applicable to any storage of two dimensional data. Furthermore, it is not limited to embodiments pertaining to storage within a cache device nor to storage in systems incorporating a cache device.

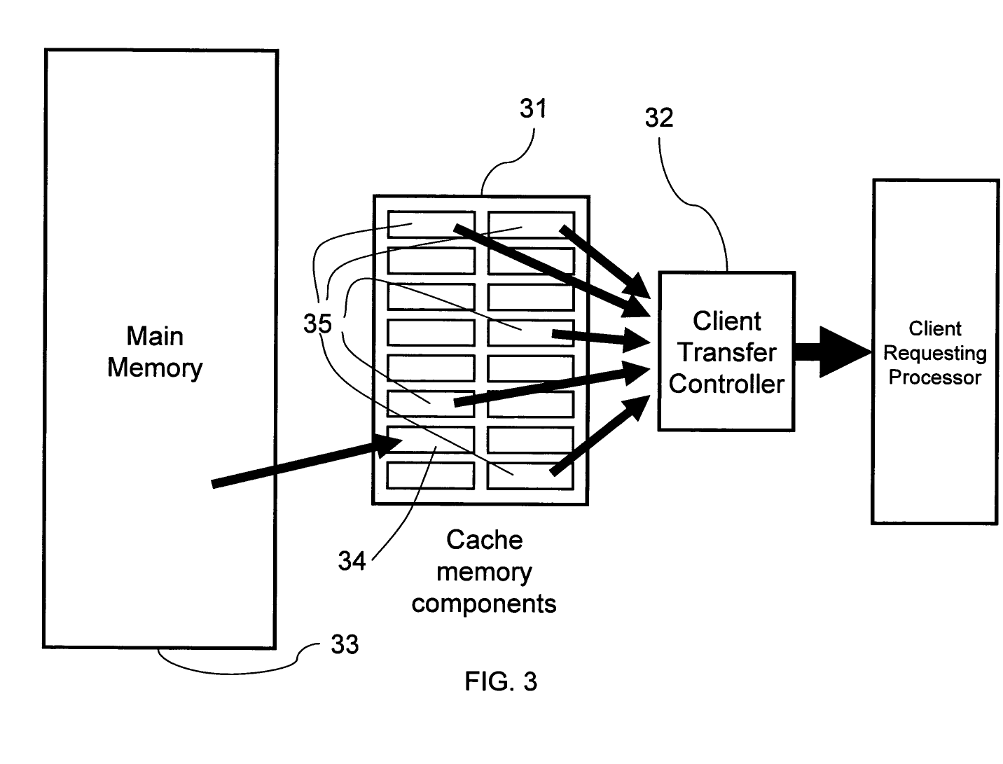

Reference is now made to FIG. 3, which illustrates a preferred embodiment of a cache memory device using a plurality of single-port memory components 31 with a controller 32 that controls access to allow a write operation to occur to a memory component 34 simultaneous with read operations on one or more other memories 35. In a preferred embodiment, only one write operation to the cache memory occurs in a clock cycle. Single-port memory components are typically used to lower the die area. The controller 32 selects a set of data to transfer to the requesting client, said set of data corresponding to a request made by the client. When selecting the set of data to transfer, the controller 32 excludes from consideration any set where a member of that set resides in a memory component that is the object of a concurrent write operation. In so excluding, the controller may read from one or more of the other components without having to wait for completion of the write operation to the component that is the object of said write operation. The exclusion effectively gives higher priority to a concurrent write operation. Thus, the memory components 31 provide performance similar to dual-ported memory components, while in fact the memory components are each single-ported, thus consuming much less die area than dual-ported memories. In other words, from the overall perspective of the cache memory subsystem, read and write is performed simultaneously despite the use of single port memories.

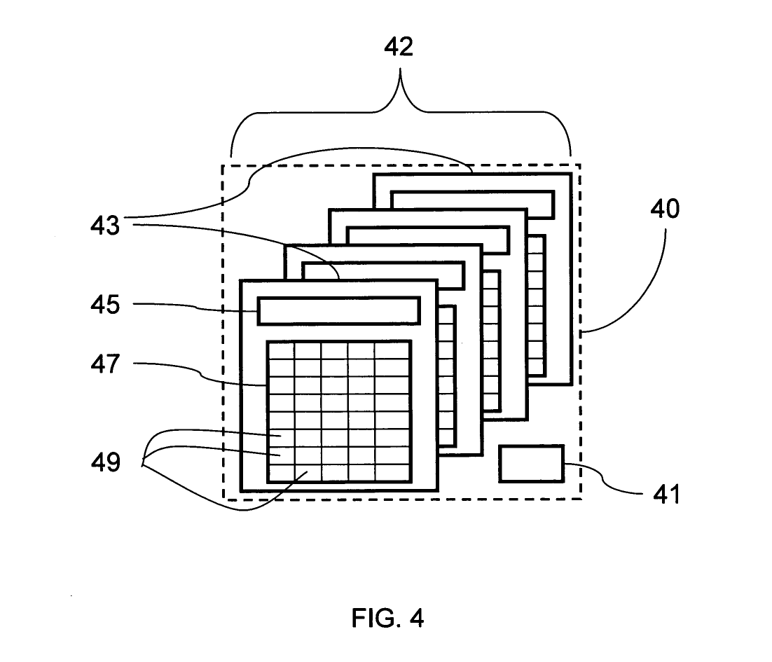

Reference is now made to FIG. 4, which illustrates the Meta-cache Control Block (MCB), according to a preferred embodiment of the present invention. By way of introduction, the MCB is a specialized content-addressable memory structure whose purpose is to maintain state information about the cache. In a preferred embodiment, the read/write bandwidth from/to the MCB is also much higher than single, dual, and common multi-ported memories. In a preferred embodiment, the MCB comprises individual elements (MCB Element or MCBE) each of which corresponds to a portion of requested main memory and a corresponding portion of the cache memory. Another feature of a preferred embodiment of the MCB is that the system accesses many (e.g., hundreds) of MCB storage elements simultaneously in a single clock cycle.

The state information maintained in the MCB may include details of one or more active requests, such as address and extent of the requested memory and a related set of MCBEs. The MCB also maintains state information about the cache memory, such as whether requested memory, or a portion thereof, is in the cache (i.e., a cache hit) or has been requested from the main memory or is in transit from the main memory to the cache memory. It also maintains address mapping information, to map from an address space referencing the main memory to the corresponding locations within a cache memory address space. By maintaining this state information in a content-addressable memory structure as described, a cache memory device may operate with greater efficiency and efficacy.

For example, in a preferred embodiment, a cache sub-system processor responsible for looking up the presence of a given memory block may consult the MCB along with the conventional cache tag memories. Depending on the results, the look-up processor may update the MCB to indicate a cache miss. An independent subsystem processor responsible for fetching memory from the main memory into the cache memory can independently consult the MCB to rapidly find a cache miss to service. Once the data is transferred from the main memory to the cache memory, the MCB is updated to indicate it is now present. Yet another independent subsystem processor managing the transfer of memory from the cache can independently and rapidly consult the MCB to detect when an appropriate set of memory blocks is available for transfer. As shown by the cited example, the MCB enables efficient and independent operation of a variety of cache subsystem processors that are able to cooperate and communicate through the medium of the MCB.

In a preferred embodiment of the cache for use in systems dealing with two-dimensional data, such as still images, or frames from a motion picture, the MCB 40 may be arranged in an embodiment as shown in FIG. 4. Global information pertaining to the entire MCB 40 is maintained in a global header 41. In this exemplary embodiment, the MCB is arranged as a set of planes 42, four in this example. Each plane 43 contains global information about the plane in a plane header 45 and also an array 47 of MCBEs 49. In this exemplary embodiment, each plane corresponds to one client request. The array 47 corresponds to the area of the request in the main memory address space, with each MCBE representing an area of the minimum size handled by the cache (a cache block, as described below). The MCBE comprises the state of the corresponding portion of the main memory relative to the cache memory, including presence in the cache and location within the cache memory.

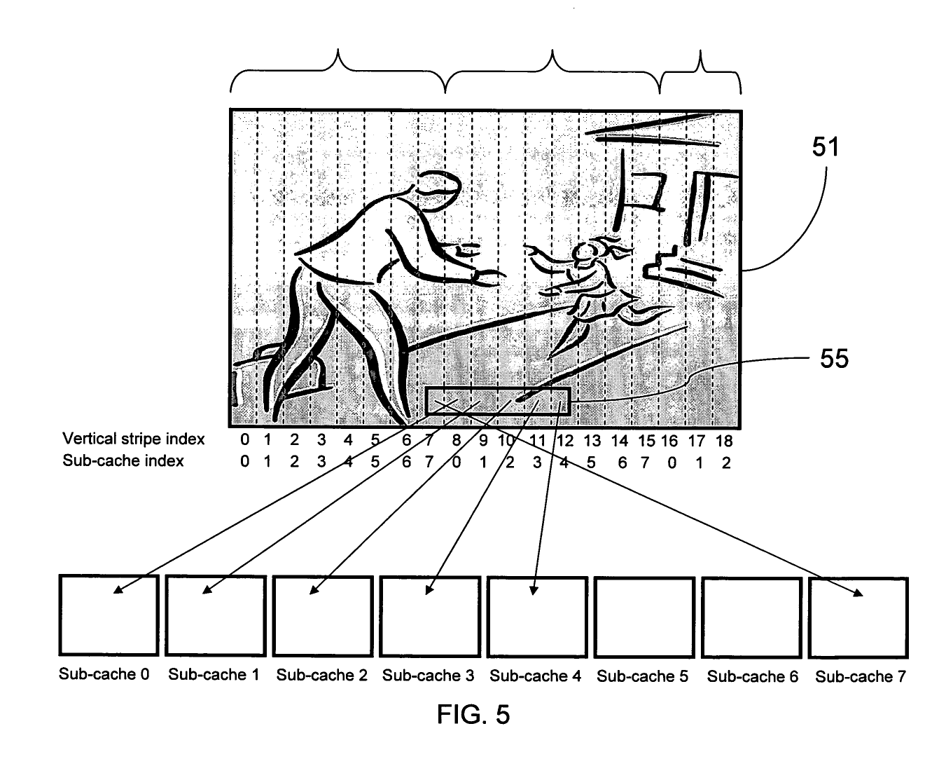

Reference is now made to FIG. 5, which provides a simplified illustration of the use of sub-caches and corresponding groups of vertical stripes in a main memory, according to a preferred embodiment of the present invention. The main memory comprises sets of two-dimensional data, such as images or frames of a motion picture and each set has a given width Wₘₐᵢₙ and height Hₘₐᵢₙ. In a preferred embodiment, each set of two-dimensional data may have a different Wₘₐᵢₙ and Hₘₐᵢₙ respectively, thus supporting, for example, a cache device used for handling multiple video streams with different resolutions. It is further given that the cache has a unit of storage of fixed size with a given width W_{cache-block} and height H_{cache-block}. These units of storage are called cache blocks. The portion of memory representing a single set of two-dimensional data (e.g., a single frame) can be logically divided into vertical stripes, each stripe of width W_{cache-block}. The cache blocks are stored in the cache memory in a plurality of J sub-caches, eight in the illustrated exemplary embodiment shown in FIG. 5. As shown, successive vertical stripes are grouped into groups of the same number of stripes as sub-caches, eight in the shown example. The first vertical stripe in each group is mapped to a first sub-cache, the second vertical stripe in each group is mapped to a second sub-cache, and so one. The effect is a periodic repetition of the mapping across the screen as shown by the numeric entries in the “Vertical stripe index” row and the corresponding numeric entries in the “Sub-cache index” row in FIG. 5.

Attention is now drawn to the portion 55 of the image 51 stored in main memory. This portion represents a single row of information of height H_{cache-block} from the image and is contained within the vertical stripes numbered (per the “Vertical stripe index”) 7, 8, 9, 10, 11, and 12 and corresponding to sub-caches 7, 0, 1, 2, 3, and 4, respectively. Thus, this portion of the image may be stored in six cache blocks. Each of the six cache blocks will be stored in its corresponding sub-cache. Thus, when all six cache blocks are present in the cache, it is possible to transmit this portion of the picture to a requesting client processor in one parallel operation, each sub-cache contributing its cache block. Furthermore, many embodiments are possible where various parameters may be tuned to achieve various cost-performance trade-offs. These parameters include, but are not limited to, the number of sub-caches, the size of cache blocks, the maximum size of a client request, number of pending requests, number of concurrent active requests, number of cache-blocks stored in each of each of the sub-caches, size of the sub-caches, associativity of each sub-cache, number of lookup pipes, number of tag memories (which can potentially be smaller than the number of sub-caches in certain embodiments), optional output pooling units, and number of pending backend requests.

Additional preferred embodiments of the present invention are now described in greater detail. These illustrative exemplary embodiments are intended to demonstrate how the various parts of the invention interact and to show how an operating cache device comprising these components may be built and operate. As stated above, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

According to an embodiment of the invention, the cache logically divides reference pictures into a grid of small blocks (called picture blocks), each block being the size of a cache block. Thus the cache block dimensions match the picture block dimensions, each of which is a bₓ (horizontal)×b_{y} (vertical) array of pixels, each pixel consisting of b_{d} (depth) bits. In a specific embodiment, the values of bₓ, and b_{y} may be optimized, for example by being made powers of two, smaller than a macroblock size. As a further optimization, the number of bits bₓ*b_{y}*b_{d} in a cache block may closely match the number of bits in a single burst or a small number of bursts of the external memory storage interface, such as (but not limited to) a DDR memory.

According to this embodiment, the cache device stores N_{cb} bₓ×b_{y} cache blocks simultaneously in N_{banks} internal cache memory banks. Each cache block can come independently from any one of many positions in any particular reference frame among a set of several simultaneous reference frames, the number of simultaneous reference frames being limited only by the amount of main memory dedicated to storage of said frames in a particular embodiment.

According to a further embodiment of the invention, various larger object shapes, not necessarily rectangular, can be stored in the cache by virtue of the fact that the images are divided into cache blocks of a finer granularity than cache devices of the prior art support. The effect of using many cache blocks of finer granularity is that common reference shapes, not necessarily rectangular in the aggregate tiling of cache blocks (e.g., circular or tree-like), are stored in the cache without special configuration. Furthermore, the use of the cache blocks adapts dynamically to the changing content of the motion picture stream being processed.

In a preferred embodiment used for video applications, the cache resides between a requesting processor, such as a video processing circuit (for example a motion estimation circuit), also called the “front-end client” or “client”, and a memory controller circuit connected to an external frame storage memory (such as DDR), together called the “main memory”, “main storage”, “external storage”, “memory backend”, or “backend”. The client makes requests of the cache for the purpose of reading reference pictures. One of the objects of this invention's cache design is to provide faster overall servicing, parallel handling, and maximize the amount of video reference picture data provided to the front-end client, while minimizing the amount of data requested from the backend, hence reducing the bandwidth requirements from the external memory.

In a preferred embodiment, the cache is configured to simultaneously hold portions of N_{ref} reference pictures of various types (for example, frames, fields, luminance, and chrominance pictures), where each picture size is configured to a maximum size of Sₓ×S_{y} pixels.

In a preferred embodiment, it is useful to relate to several different addressing schemes, or modes, used to reference data in various units throughout the embodiment. For example, one or more of the following address spaces may apply when used in an embodiment for processing streams of motion pictures:
1. The requesting processor client's “virtual address”, consisting of picture number, color (e.g., luminance vs. chrominance), and x and y coordinates (which may also be negative, i.e., out-of-picture). These represent a two-dimensional location within either the luminance or chrominance image of a specific frame (i.e., picture) out of many that may be available in the main memory.
2. The same virtual address mentioned in 1, but with the x and y coordinates adjusted so it is within the picture.
3. A mapping of the virtual address mentioned in 2, in which the four dimensions (picture number, color, x, y) are mapped to a one dimensional (scalar) address. In a preferred embodiment, this mapping comprises two steps:
   a. Concatenation of the fields picture number, color, x (except the three low-order bits in a preferred embodiment), and y.
   b. Bit permutation of the concatenated result.
4. A physical address in the cache, derived from the addresses mentioned in 2 and 3, where the physical address includes the sub-cache number (e.g., using x from step 2 above, the sub-cache number would be x modulo 8 in a preferred embodiment) and address inside the sub-cache (e.g., using the low-order bits of the one-dimensional address mentioned in 3.).
5. A mapping of the address mentioned in 2 above, of the adjusted four-dimensional address space (picture no, color, x, y) to the physical address space of the backend main memory storing the frames. For example, in an embodiment using DDR memory, the mapping would be to an address space with bank, row and column.

In an illustrative preferred embodiment, the communication flow proceeds as follows:
1. The communication with the front-end client starts when the cache device receives a client request from the front-end client specifying a particular rectangular area the client wishes to read. This specification includes the picture number, picture type, coordinates in pixels (REQ_X, REQ_Y) pointing to the top-left corner of the requested reference area, and two size parameters, REQ_SIZEX and REQ_SIZEY, specifying the extent in pixels in each direction of the requested reference area.
   There are several advantages in this mode of operation of the present invention compared to the state of the art. These include:
      i. the client decides on the candidate reference locations in which it wishes to perform a search for a current block, and those locations may be anywhere in the frame
      ii. the locations may be on any of several frames,
      iii. the locations may completely change from one current block to the next block, and even completely change from one sub-block of a macroblock (such as those defined by the H.264 specification) to the next.
   These advantages are in sharp contrast to prior art cache designs, which hold one or two rectangular search areas of predetermined, fixed size and in which the search area of the next macroblock is completely determined in advance by the search area of the previous macroblock, i.e., by sliding the rectangular search area one macroblock to the right.
2. An incoming client request is then divided into smaller chunks, each one the size of a single bₓ×b_{y} cache block. Chunks at edges of the requested area that are not aligned with the grid have their addresses adjusted to include the areas up to the edges of the corresponding block of the picture.
3. The request is then transferred to a lookup engine, which initiates a parallel lookup process using N₁ₚ lookup pipes circuits on the cache blocks. The lookup process verifies for each cache block whether it is already present in the cache. This is done by
   a. reducing the two-dimensional virtual address into a single-dimensional address,
   b. mapping the virtual address using a programmable permutation, and
   c. checking the cache block using a group of tag memories in a process described below.
4. The missing cache blocks are then brought into the cache from the external memory using the memory backend circuit. To facilitate tracking of the cache blocks currently in service in the cache, a specialized content addressable memory structure is used—the Meta-cache Control Block, or MCB. The MCB supports several concurrent operations on a group of block-tracking storage elements.
5. Finally, the reference picture area corresponding to the client request is transmitted back to the client in convenient line-based raster scan fashion from the cache at a much faster rate than that at which the backend can transfer blocks into the cache.

In a preferred embodiment, the cache supports N_{active} simultaneous active client requests for reference areas. Partial overlap of the requests is automatically identified, so that if a particular cache block is referenced in two or more simultaneous requests and is missing in the cache, it will be fetched from the backend only once, for the benefit of all the requests.

Furthermore, if the processing of a particular request is stalled, waiting for the backend to complete a cache block transfer, the mechanisms of the present embodiments continue to service other pending requests that hit (i.e., are already present in) the cache, allowing the client to receive those other requests in the meanwhile.

An additional capability provided by the present embodiments is automatic support for partial or full out-of-picture motion vectors, which is used in newer compression standards such as MPEG-4 and H.264. The present embodiments perform field and frame-based pixel padding automatically for out-of-picture regions, removing this burden from the client. Thus, if a client requests an area that is partially out of the frame, the cache will satisfy the request in a manner transparent to the client.

The cache also supports special storage and accessing modes for interlaced video contents, while providing the client with a simple interface to receive a field or frame region, regardless of the storage format of the reference picture or pictures involved in that request. For example, a top field reference area in an interlaced coded content can be extracted out of a frame picture, or vice versa—a frame area can be constructed by combining different fields of different frame pictures, which can be used, for example, to aid in performing a real-time 3:2 pulldown process. Those modes will be explained in more detail below.

For purposes of illustration only, the exemplary preferred embodiment of the present invention described in the drawings uses the following parameters:

a cache block of size bₓ=8, b_{y}=4, with b_{d}=8-bit pixels;

N_{banks}=8 sub-caches, each of them Nₐ way associative;

Nₐ=4 (i.e., the cache is 4-way associative);

N_{tags}=8 tag memories;

maximum picture size Sₓ=1920, S_{y}=1088;

maximum client request size 28 by 28 pixels;

N_{active}=4 simultaneous active client requests;

N_{pending}=4 pending client requests in input pool

N₁ₚ=5 lookup pipes;

and

client transfer rate of two lines of 28 pixels each simultaneously in one clock cycle.

It is understood that many configurations of these and other parameters are possible within the scope of the present invention and different embodiments may reflect this variety.

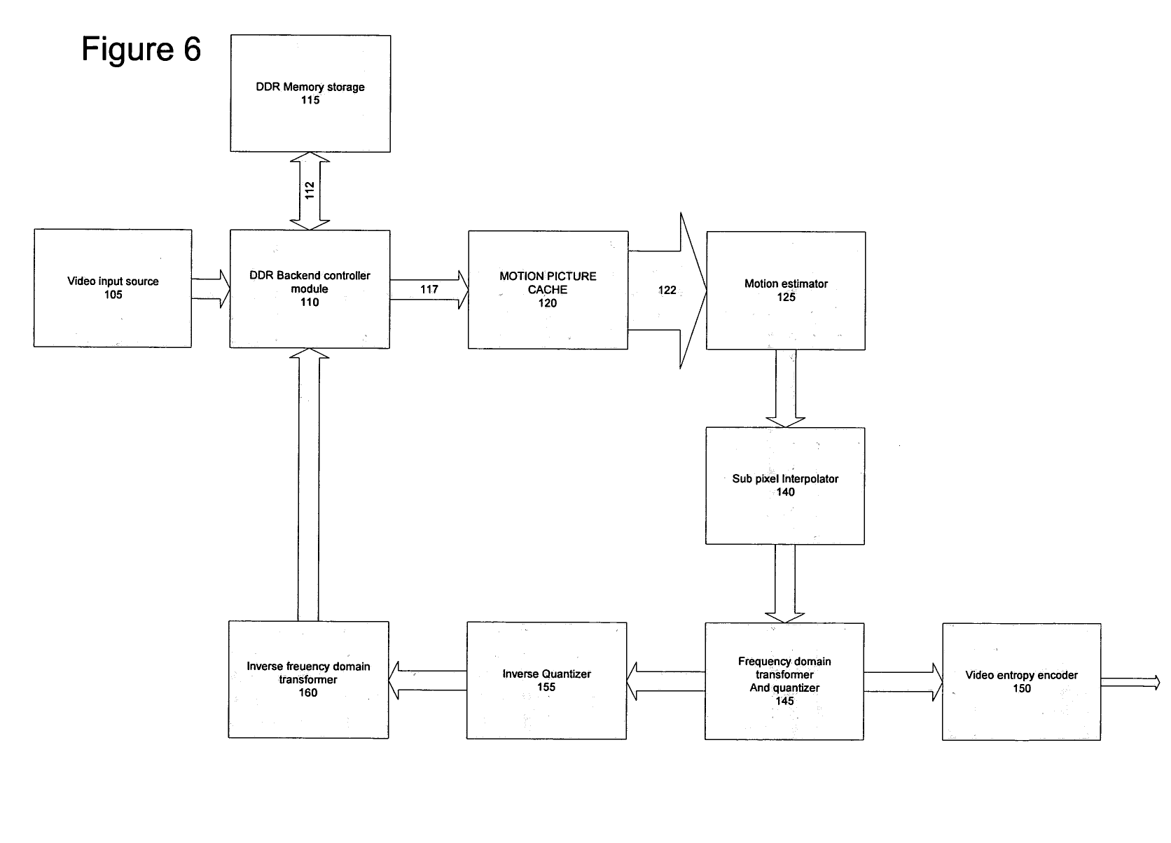

FIG. 6 shows a typical fine-grained (i.e., pixel-sized or less) motion estimation circuit incorporating the cache device of the present embodiments in the context of a modern video encoder circuit. Video input source 105 stores pictures in the memory storage 115 using the storage backend controller 110. The cache 120 provides access to the stored pictures when requested by the motion estimator 125. The bus 122 between the cache 120 and the motion estimator 125 has a higher speed and bandwidth than the buses 112 and 117, which connect the backend controller to, respectively, the memory storage 115 and the cache 120.

Once the motion estimator 125 decides on the best candidates, the reference area is usually interpolated by the sub-pixel interpolator 140, passed to a frequency domain transformer and quantizer 145, and then entropy coded using variable length, arithmetic, or other means by the video entropy encoder 150. The encoder 150 provides the final compressed video bitstream output of the overall video encoder circuit.

In parallel, the frequency domain transformer output is passed through an inverse quantizer 155, an inverse frequency domain transformer 160, and stored back in the storage 115 using the backend controller module 110.

As part of the video encoding process, each macroblock of the current picture is divided into smaller sub-blocks. Then, the motion estimator 125 needs to find the best reference sub-block for each current sub-block among several frames.

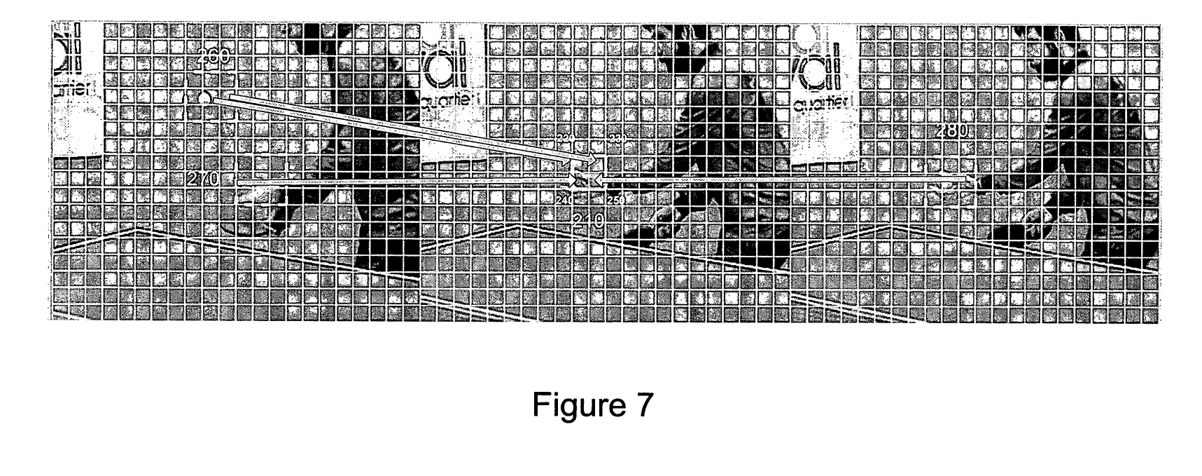

With reference to FIG. 7, current frame 202 shows an example of a typical 16×16 macroblock 210 divided by the motion estimator into four 8×8 blocks 220, 230, 240, 250. In this illustrative example, the best reference candidate for each of the 8×8 blocks comes from different search areas within a particular picture and even from different pictures. In the example, the two 8×8 blocks 220 and 230 come from adjacent blocks in the same search area 260 within reference picture 204, the third 8×8 block 240 from a completely different search area 270 within reference picture 204, and the fourth block 250 from search area 280 in a different picture 206 altogether. One advantage of the present invention is that the cache can simultaneously hold all four candidates (or more), where a cache conforming to the prior art would hold only the first two.

Each picture is divided into small bₓ×b_{y} blocks, 8×4 in the present example. This area is smaller than the typical 16×16 macroblock size, as can be seen in FIG. 7. It is a collection of those 8×4 blocks that is stored in the cache at a given time instance, where each 8×4 block is independent, and can come from different pictures or different areas inside the picture, allowing the cache to store many larger and disparate areas simultaneously.

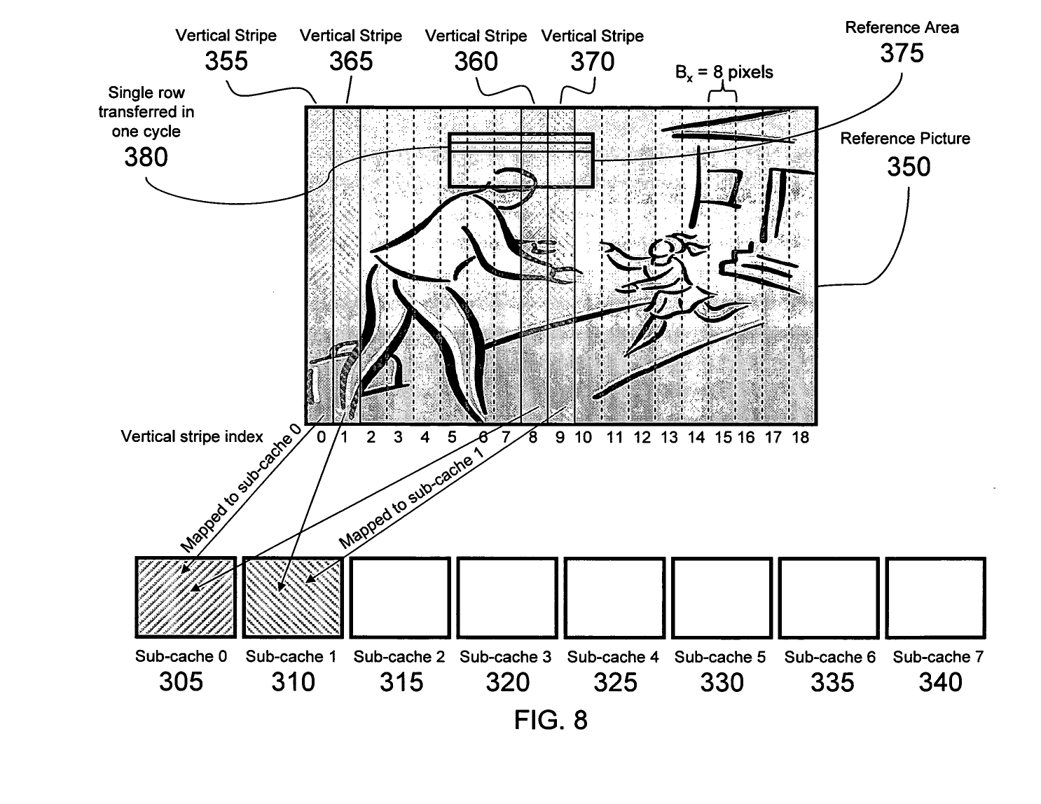

FIG. 8 schematically shows the cache sub-divided into N_{banks} sub-caches 305, 310, 315, 320, 325, 330, 335 and 340, a total of 8 in a preferred embodiment. The reference picture 350 is divided into logical vertical stripes, where the width of each stripe is the same as bₓ, the width of a cache block. For purposes of mapping the vertical stripes to the sub-caches, the vertical stripes are numbered Iₛₜᵣᵢₚₑ from 0 to Nₛₜᵣᵢₚₑₛ. The mapping from a particular stripe Iₛₜᵣᵢₚₑ to its corresponding sub-cache I_{cache} is calculated by the formula I_{cache}=Iₛₜᵣᵢₚₑ modulo N_{banks}. Thus the group of all vertical stripes with the same value for I_{cache} map to a single sub-cache.

For example, the vertical stripes 355 and 360 map into sub-cache 305, while stripes 365 and 370 map into sub-cache 310. In an embodiment where the maximum horizontal client request size is smaller than N_{banks}*bₓ pixels, this scheme ensures that the client-requested horizontal pixels are always present in the cache simultaneously and enables the cache to transfer one or more complete rows 380 from the reference area 375 back to the client in a single clock cycle.

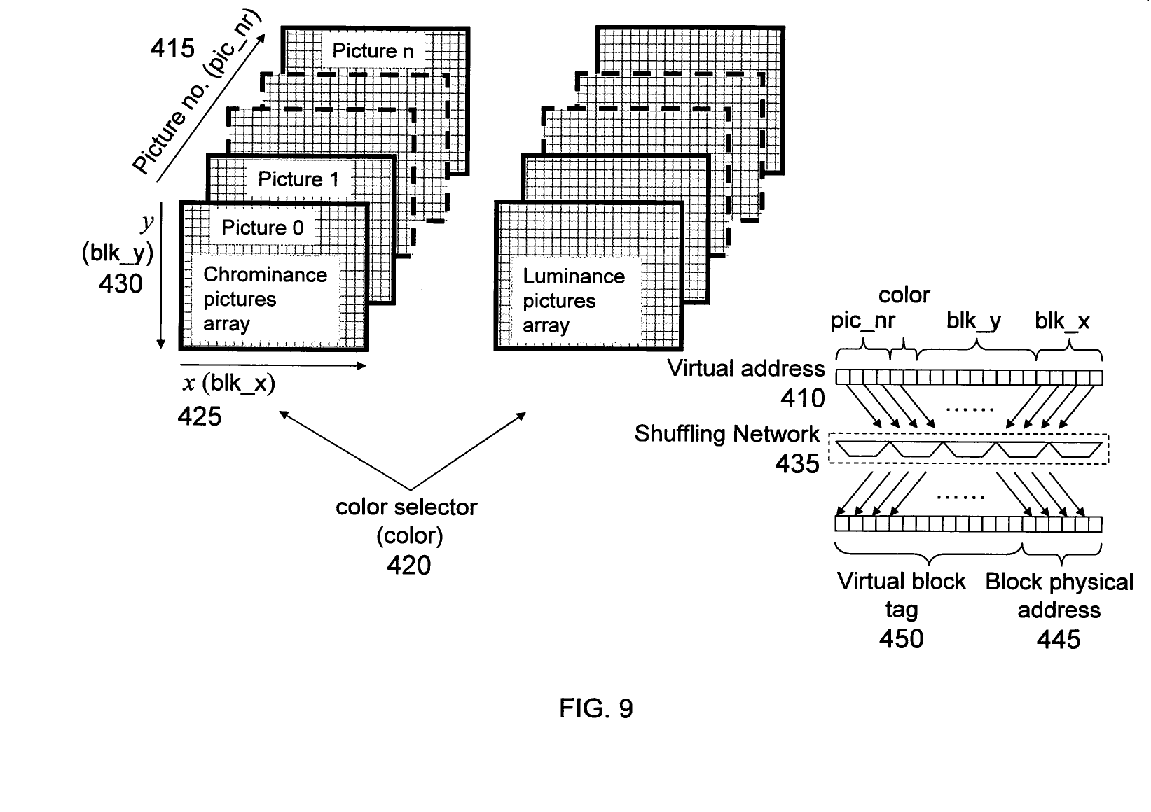

The above group of picture block elements that map to a particular single sub-cache (such as 355 and 360) contend for placement inside the same sub-cache (in this example, 305). (Note that adjacent vertical stripes (such as 355 and 365) map to different sub-caches and do not contend.) To alleviate the contention, a programmable two-dimensional to single-dimensional mapping is performed, along with further division of each of the sub-caches into several associative sets, (four in the preferred embodiment). FIG. 9 describes the mapping process.

With reference to FIG. 9, in the mapping process, a virtual address is assigned to each reference block from each of the cached pictures. A preferred method to create the virtual address 410 (and the one illustrated in FIG. 9) is to concatenate the bit representations of the picture number 415 (pic_nr), color 420, and the two dimensional co-ordinates, horizontal 425 and vertical 430 (blk_x and blk_y, respectively). In the preferred embodiment shown, the virtual address of a block may also be described mathematically by the formula pic_nr*65536+color*16384+blk_y*32+blk_x/8 (the horizontal blk_x co-ordinate is divided by 8 to correspond to the 8 independent sub-caches in the present exemplary embodiment, as depicted in the example shown in FIG. 8). In this illustrative preferred embodiment, the allocation of space in the resultant virtual address is:

Blk_x::5 bits (after dividing by 8 to discard 3 low-order bits)

blk_y::9 bits

color::2 bits

pic_nr::4 bits

It is understood that this particular mapping is dependent on the various parameters chosen and would be adapted accordingly to fit other embodiments.

To further alleviate block contention, the single-dimension virtual address is passed through a programmable multiplexer shuffling network 435, which performs a permutation of the original concatenated bits. This allows fine-tuning of how blocks in the original vertical stripes group are mapped to the physical address space, and which blocks map to the same physical address. For example, in one embodiment, the mapping used can be [5:0], [6:1], [7:2], [8:3], [0:4], [1:5], [2:6], [3:7], [4,8], [9:9], [10:10], [11:11], [12:12], [13:13], [14:14], [15:15], [16:16], [17:17], [18:18], and [19:19], which maps bit 5 into bit 0, bit 6 into bit 1, etc. This particular mapping, for example for a preferred embodiment, improves the cache hit ratio by mapping locally vertically adjacent two-dimensional blocks, as well as nearby horizontal (i.e., successive horizontal blocks spaced eight blocks apart in this embodiment) into different physical locations in each sub-cache, thereby reducing the incidence of collisions.

Each sub-cache is further divided into Nₐ associative sets (4 in the preferred embodiment shown) such that up to Nₐ virtual blocks that happen to map into the same physical address may simultaneously co-exist in the cache, which further alleviates block contention.

After creating a one-dimensional virtual address and mapping it as described above, the least significant bits 445 (six in the preferred embodiment shown) are used as the block physical address, and describe the location of that block inside the physical cache data memories. The remaining 14 bits 450 are used to differentiate between the various virtual blocks that can be mapped to the same physical location in the manner commonly employed in the art for n-way associative cache memories with the use of tags.

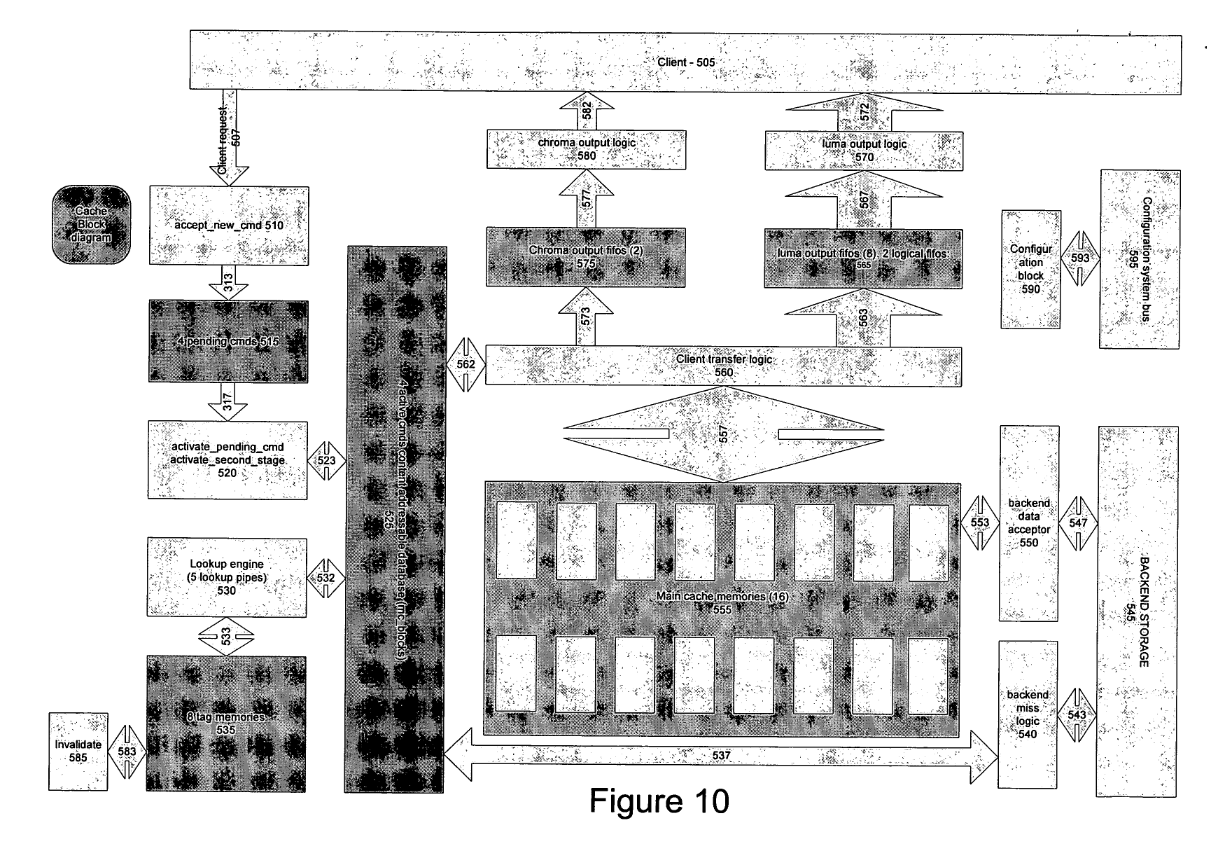

FIG. 10 shows a hierarchical block overview of the invention's cache architecture. Some aspects of the architecture are described in more detail in separate figures.

The cache architecture in a preferred embodiment is described below from the point of view of the actions performed in response to a single client request from the moment it is received by the cache until the moment the cache satisfies the request. It should be born in mind, however, that multiple client requests can be active simultaneously, and each one can be in a different processing stage. In that regard, the invention's cache micro architecture is designed as a pipeline; although there is an initial latency, afterwards data is streamed to the client at a very high rate—much faster than 1/latency (up to 140 Gbits/sec in one particular experimental embodiment).

For each sub-block, the client 505, assumed to be a motion estimator in this example, passes to the cache an area request 507 for an area of memory. A request can be submitted every clock cycle.

Each request contains the following arguments:
1. picture 0 number
2. color
3. x-axis left position (REQ_X)
4. y-axis top position (REQ_Y)
5. x-axis horizontal extent (REQ_SIZEX)
6. y-axis vertical extent (REQ_SIZEY)
7. request type
8. request subtype
9. field 0 number
10. field 1 number
11. picture 1 number
12. request id.

The request, along with its arguments, thus describes a rectangular reference area in one or two of available reference pictures, as well as the way in which this reference area is to be delivered to the client.

Each of the arguments of the area request is now described in greater detail.

Argument 1, the picture number, contains an index that refers to one of a group of 16 (in this embodiment) reference pictures. Each reference picture has an associated frame descriptor that resides in the configuration block 590. The descriptor describes the picture size, storage format, and external storage address at which it can be found. In this embodiment, two groups of reference pictures are maintained, one group for the luminance component of the pictures, and one group for the chrominance Cb/Cr color components, selected by argument 2—color.

Arguments 3 and 4 locate the top-left corner of the requested rectangular reference area inside the picture specified by arguments 1 and 2. Arguments 5 and 6 describe the width and height (horizontal and vertical extent) of the requested rectangular area.

Argument 7, the request type, specifies the action for the cache to perform on the reference area. In this embodiment, it can be either

1. read, or

2. bring_cache.

The read request type is a common request type used by the client to ask for a particular reference picture area from the cache. The bring_cache request type, on the other hand, asks the cache to load the specified rectangular area into the cache, without providing it to the client (i.e., a pre-fetch or pre-load action). This mechanism can be used by the client to reduce the cache miss penalty, by interleaving bring_cache requests for future reference areas in parallel to read requests for current reference areas. When those areas are needed, they will already be available inside the cache.

Moving picture video can be either interlaced or progressive (also called full frame). In progressive video, an entire frame is generated at once (for example, film material is usually shot at a rate of 1/24 frames per second, thus an entire frame is shown every 1/24 second). On the other hand, an interlaced frame comprises two fields, one containing the even scan lines of the picture while the other contains the odd scan lines of the picture. Each interlaced field in a frame has a time offset from the other field. For example, in NTSC video, each field is at approximately 1/60 second intervals. Thus, within a frame the time difference between the even and odd fields is 1/60 second, versus 0 in the progressive case, i.e., in progressive video, both fields are present together.

One aspect of the present invention's cache is that it can be optimized for both interlaced and progressive applications. This is achieved by making the basic bₓ×b_{y} cache block (8×4 in the present example) contain by lines from either a single field, or both fields (i.e., from a single progressive frame). The backend storage can, in a similar manner, be optimized either for field or frame storage by deciding whether its basic block, typically, the amount of memory delivered in a single burst, will contain data from a single field or from both fields. Additionally, a video can switch between interlaced and progressive content, and occasionally a field can be dropped altogether, as done in cadence correction (3:2 pulldown processing of film material which was pulled up from cinema at 24 frames per second to NTSC television at ˜30 frames per second). Video compression art therefore supports both interlaced and progressive coding tools for each macroblock, and the cache client may want to consider both frame and field reference areas.

It adds considerable complexity to the client to support the various ways in which a field can be extracted from a frame, or a frame can be combined from several fields. The present embodiment of the cache therefore performs extraction or combining of fields for the client, and uses argument 8, the request subtype to communicate the desired action. The client may use the request subtype to specify the method in which interlaced and progressive video storage formats are to be handled before being returned to the client. The method may be one of:

1. frame_from_frame,

2. field_from_frame,

3: field_from_field,

4: frame_from_fields,

5: frame_from_field_frame,

6: frame_from_frame_field,

7: frame_from_frames.

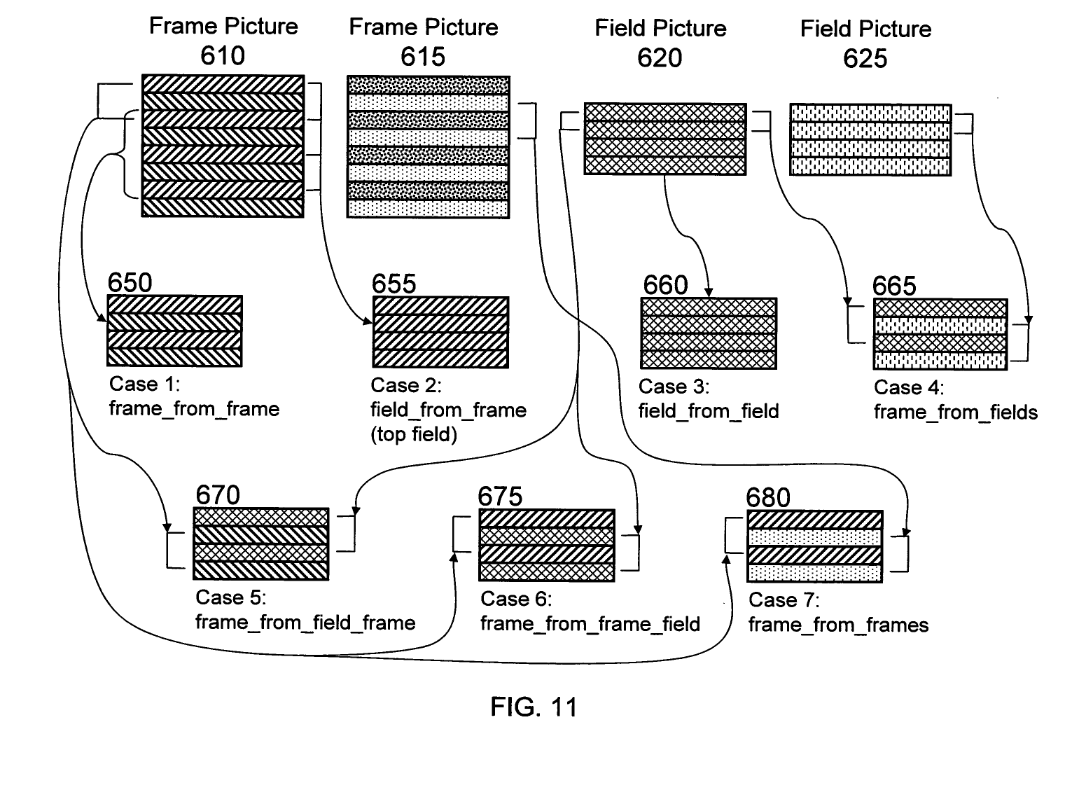

The handling of these different request subtypes is illustrated with reference to FIG. 11: In the usual frame_from_frame case 1, the client requests a frame reference area 650 from a picture stored in frame format 610. In case 2, field_from_frame, the picture is stored in the memory storage in frame format, but the client wants to receive a single field out of that frame, selected by argument 9, the field 0 number. Example 655 shows a top field area extracted from a frame picture 610. In case 3, field_from_field, the client wants to receive a field area 660 from a field picture 620. In case 4, frame_from_fields, the client wants to create a new frame area 665 by combining two fields 620 and 625 stored separately, specified by the two picture numbers (argument 1 and 11). In case 5, frame_from_field_frame, the present embodiment of the cache generates a frame area 670 from two fields, the top field coming from a field 620, specified by argument 1—picture 0 number, and the bottom field from a frame 610, specified by argument 11—picture 1 number (either from its top or bottom field, said field being selected by argument 10, field 1 number). In case 6, frame_from_frame_field, the frame area 675 consists of two fields, the top field coming from a frame 610 specified by argument 1—picture 0 number, while the specific field within frame 610 is specified by argument 9—field 0 number, and the bottom field coming from a field image 620 specified by argument 11—picture 1 number. Finally, in case 7, frame_from_frames, two fields are extracted from two different frames 610 and 615 (top field specified by arguments 1 and 9, picture 0 number and field 0 number respectively; bottom field specified by arguments 11 and 10, picture 1 number and field 1 number respectively) and combined to form a single frame area 680.

Arguments 9-11 are sub-arguments for the subtype argument, as described above. Finally, argument 12, request id, is a client-supplied identifier associated with the request.

In this preferred embodiment, data will be returned to the client in a sequential vertical manner, one or two lines at the same clock cycle, each line consisting of REQ_SIZEX pixels, at most 28 in the present example. When returning data back to the client, identifier argument 12 will be sent along with the data, and may be used by the client to identify to which of its requests the currently supplied line belongs.

Returning to FIG. 10, the cache new request acceptor, 510, upon receiving the new request, notes the request arrival time, and adds the request to a list of pending requests 515. As noted above, in this exemplary preferred embodiment, N_{pending}=4 pending requests are supported.

The cache keeps track of and simultaneously handles N_{active} requests (in the current example, N_{active}=4). So from the client's point of view, 8 request slots are available (N_{pending}+N_{active}). The plurality of input request slots, mentioned above as an input request pooling unit, alleviates the single request miss latency in the case where a request must be serviced from the external storage, since other requests can be transferred to the client during this time. Thus, utilization of the cache-to-client transfer interface is improved, avoiding the bandwidth penalty associated with the backend storage.

Upon arrival at the pending pool, the rectangular block request is aligned with the grid of bₓ×b_{y} blocks, and field/frame co-ordinates are adjusted according to the request type and storage format of the reference pictures used in that request by the acceptor block 510.

Each active request is assigned a processing state, which in this preferred embodiment is one of LOOKUP, ASK_FINISHED, LOADING, and TRANSFER. Each active request transitions between those states in the order listed, subject to the condition that at a particular time, only a single request can be in the LOOKUP and ASK_FINISHED states, but several active requests can simultaneously be in the LOADING and TRANSFER states.

In a preferred embodiment, whenever a new active request slot is available and the lookup pipes are idle, and provided that at least one request is pending, the oldest pending request is activated by the activation block 520. In other preferred embodiments, other criteria may also be applied, for example, priority may be given to requests to read over requests to pre-fetch (bring_cache), or priority may be given to a request for memory representing a luminance image over a request for a chrominance image. In so activating, the request is transferred to an active slot (i.e., an available plane) in the MCB 525 with the state being assigned to a LOOKUP state. In some preferred embodiments, criteria for selecting a particular MCB plane may be employed, for example, if optional output pooling units are employed, the state of the output pooling units may taken into consideration.

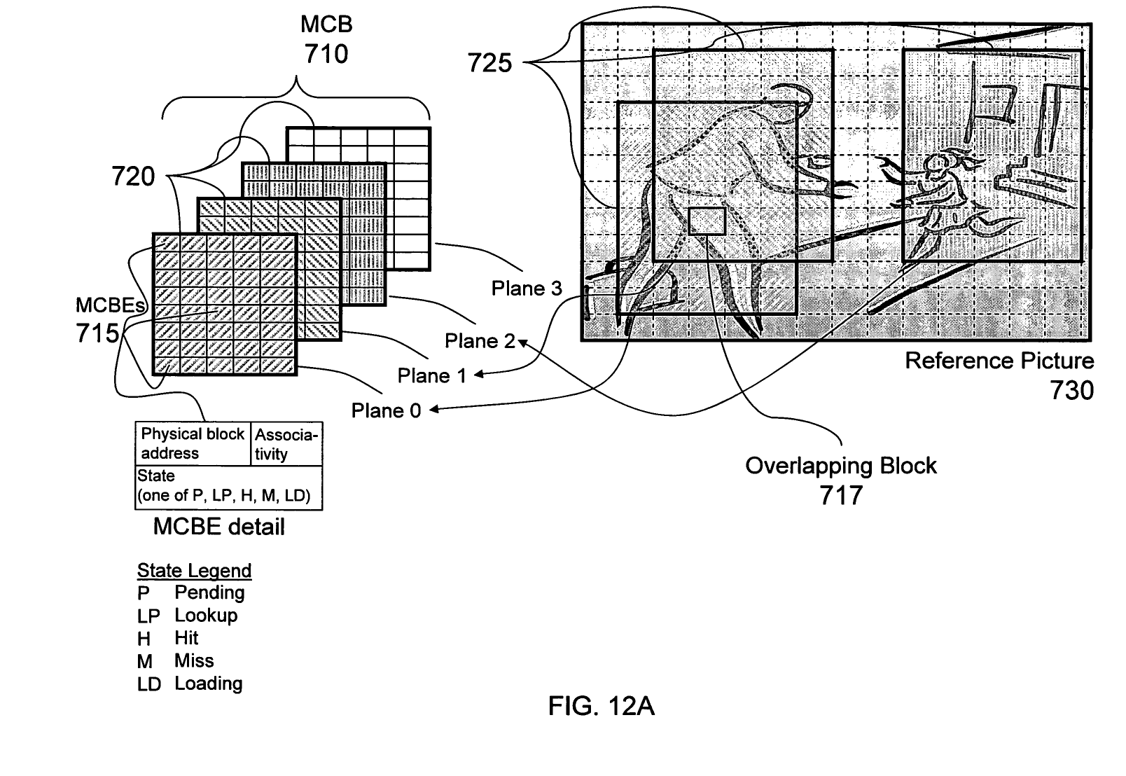

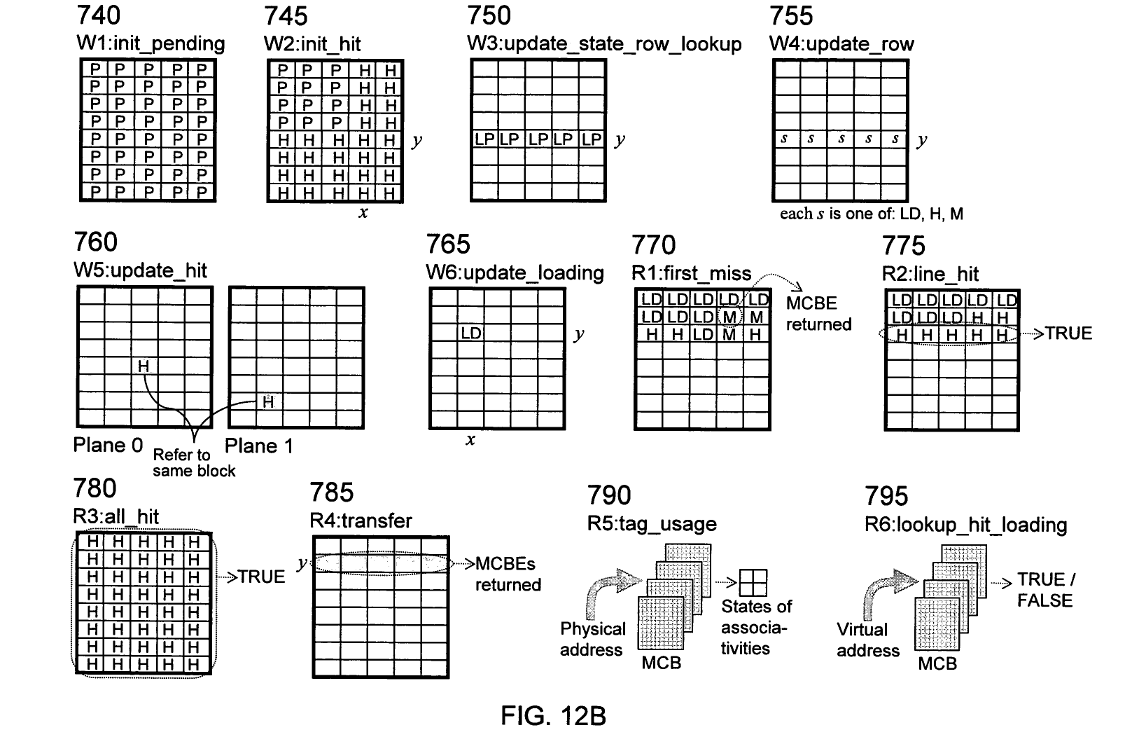

Reference is now made to FIG. 12A, which further describes the content-addressable memory structure, the MCB.

The MCB contains storage elements 715 (MCB Elements or MCBE) that keep track of the on-going activity in the cache. The MCB is a three-dimensional cube 710 where each plane 720 of the MCB relates to a rectangle 725 of a reference picture 730. The rectangle so referenced comprises a matrix of Rₓ×R_{y} blocks, where each block is bₓ×b_{y} pixels in size. As noted earlier, the block size imposes a grid structure on the picture (i.e. the total number of horizontal blocks is roundup (Sₓ/bₓ) and the total number of vertical blocks is roundup (S_{y}/b_{y}). Each rectangle 725 is aligned to this grid by adjusting the address outward in all four directions as needed. Each MCBE relates to the corresponding cache block containing the corresponding portion of the picture.

A unique feature of the MCB is that, in contrast to a standard memory, many storage elements can be accessed and modified simultaneously in one clock cycle, with access patterns unique to the needs of this embodiment's cache system.

In the presently described preferred embodiment, the MCB cube comprises four planes. Each of the four planes corresponds to one active request. Each plane comprises per-plane header information related to the corresponding request, such as its location and extent, picture number, color, request id, and timestamp. The exact header information required varies depending on the embodiment and parameters. Each plane in the presently described embodiment further comprises 40 storage elements arranged as a matrix of 5 horizontal×8 vertical MCBEs representing storage of 40 pixels horizontal×32 pixels vertical. This size is dictated by the choice of cache block size and maximum request size. As stated above, in this embodiment the request block maximum size is 28×28 pixels. Horizontally, the request block may start anywhere within a grid block, e.g., at the seventh pixel. In this example, with a 28-pixel wide request, the width would extend horizontally to include the first two pixels of the fifth consecutive block. Similarly, in the vertical direction, allowing for any alignment of the requested block, the maximum vertical size is 32 bits, yielding the requirement for an array of 5×8 MCBEs to minimally cover the area which may contain the maximum-sized request.

With four planes there is a total of 160 MCBEs in the MCB cube. Each MCBE describes one cache block, which as noted is 8×4 pixels. Thus, in this embodiment, there is a total of 1280 (40×32) pixels described by a single plane and 5,120 (40×32×4) pixels described by the entire cube.

Each MCB storage element (MCBE) is a descriptor for the MCBE's associated cache block. Each MCBE contains the physical block address and associativity index. The physical block address and associativity index defines the associated cache block's position inside its local sub-cache. The MCBE further comprises state information that describes the current action being performed on the referenced cache block (one of: PENDING, LOOKUP, HIT, MISS, or LOADING in the presently described embodiment).

In the presently described preferred embodiment, the MCB supports the following set of six write operations:
W1. init_pending,
W2. init_hit,
W3. update_state_row_lookup,
W4. update_row,
W5. update_hit,
W6. update_state_loading,
   and the following set of six read operations:
R1: first_miss,
R2: line_hit,
R3: all_hit,
R4: transfer,
R5: tag_usage, and
R6: lookup_hit_loading.

Multiple operations can be done simultaneously in a single clock cycle, and every operation can affect or process multiple MCBEs simultaneously. Some operations are MCBE-oriented, some are plane-oriented, and some are cube-oriented, affecting all storage elements.

Each of the operations is now described in greater detail with reference to FIG. 12B, where each write operation is shown with an example in simplified form of how one or more MCB planes is affected by the write operation. The grid represents the MCBEs within a plane. The letters within each cell of the grid represent the state of the example MCBE (after the write operation) according to the State Legend shown in FIG. 12A. For each read operation, a simplified form of the operation is illustrated showing example states, inputs, and outputs as relevant.

Operation W1, init_pending 740, simultaneously initializes all the MCBEs in a plane to the pending state.

Operation W2, init_hit 745, simultaneously initializes all the MCBEs in a specified MCB plane to the right of the specified x coordinate (inclusive) to the HIT state, as well as all the MCBEs below the specified y coordinate (inclusive) to the HIT state, leaving only the upper left corner of the plane (extending down and to the right to the coordinates (x−1, y−1) as PENDING. W1 and W2 are used by the activation block 520 when activating a new pending request. W2 is preferably used when the rectangle of interest is smaller than the whole plane. Applying the HIT state for the “don't care” region means that the whole plane will register as HIT when the actual area of interest is truly HIT. This is effectively an optimization of the described embodiment to simplify the circuitry for later recognizing that the row or the plane is completely hit (i.e., R2, R3). In this embodiment, the W1 and W2 operations execute simultaneously in single clock cycle.

Operation W3, update_state_row_lookup 750, initializes an entire horizontal line of a specified MCB plane to the LOOKUP state.

Operation W4, update_row 755, updates an entire row of a specified plane with new block address and associativity index, as well as setting the states of that row to one of the LOADING, HIT or MISS states.

Operation W5, update_hit 760, is a cube operation working on the entire MCB. It is used to update all the MCBes that point to the same virtual picture block (i.e., which share the picture number, color, and picture block co-ordinates), to the HIT state. The effect of this operation is to allow the cache of the present embodiments to support overlaps of simultaneously active client requests. In FIG. 12B is shown an example corresponding to updating the state for two MCBEs, one in Plane 0 and one in Plane 1, each associated with the overlapping block 717 shown in FIG. 12A.

As noted, each active client request is assigned a plane in the MCB, and all elements inside a single MCB plane are ensured not to overlap (since they reference discrete tiled blocks in the picture). However, it is possible that the blocks referenced by elements from one plane in the cube overlap those referenced in another plane as illustrated in FIG. 12A, Plane 0 and Plane 1. In other words, there may be simultaneous requests for areas of the picture that overlap. The use of the W5 operation on the MCB simultaneously updates all MCBEs in all planes that have the same virtual picture address, effectively notifying all the requests corresponding to those planes that the overlapping block has arrived. The use of W5 further ensures that a block common to several requests, such as the example 717 shown in FIG. 12A, is brought into the cache only once.

Operation W6, update_loading 765, modifies the state of a single MCBE to the LOADING state.

Operation R1, first_miss 770, is an MCB cube operation to find the first storage element that is set to a state of MISS. It selects and returns the first MCBE whose state is set to MISS. “First” is defined in this embodiment as the first MCBE (as would be found when stepping through a plane in raster scan fashion) of the plane corresponding to the oldest request.

Operation R2, line_hit 775, returns TRUE when all the MCBEs in the specified row of the specified plane are in the HIT state.

Operation R3, all_hit 780, returns TRUE when all the MCBEs in the specified plane are in the HIT state.

Operation R4, transfer 785, For a specified row in a specified plane, returns the MCBEs in that row.

Operation R5, tag_usage 790, is a cube operation that, for a specified physical block address, returns the “in-use” state of all four associativities (per the presently described preferred embodiment). By “in-use” is meant, “is this associativity of this physical address referenced by any of the MCBEs in the cube?” This operation is used when all associativities for a given physical block address are occupied and one must be selected for overwriting. This operation is used to ensure that a currently in-use block will not be selected.

Operation R6, lookup_hit_loading 795, is a cube operation that returns TRUE when for a specified virtual picture block, there is any referencing MCBE currently with MISS or LOADING state.

Returning to FIG. 10, the lookup engine 530, if idle, selects one of the active requests from the MCB giving priority to the oldest arrival time as noted by the new request acceptor 510. The request has already been aligned to the blocks grid by the acceptor block and mapped onto a particular MCB plane by the activation block 520. In this preferred embodiment, each such MCB plane contains up to 8 valid lines, each of them containing up to 5 valid MCBEs. The lookup proceeds in parallel on all the MCBE blocks in the same horizontal line using multiple lookup pipes (i.e., up to five lookup pipes, one for each MCBE in the line, as described above for this preferred embodiment).

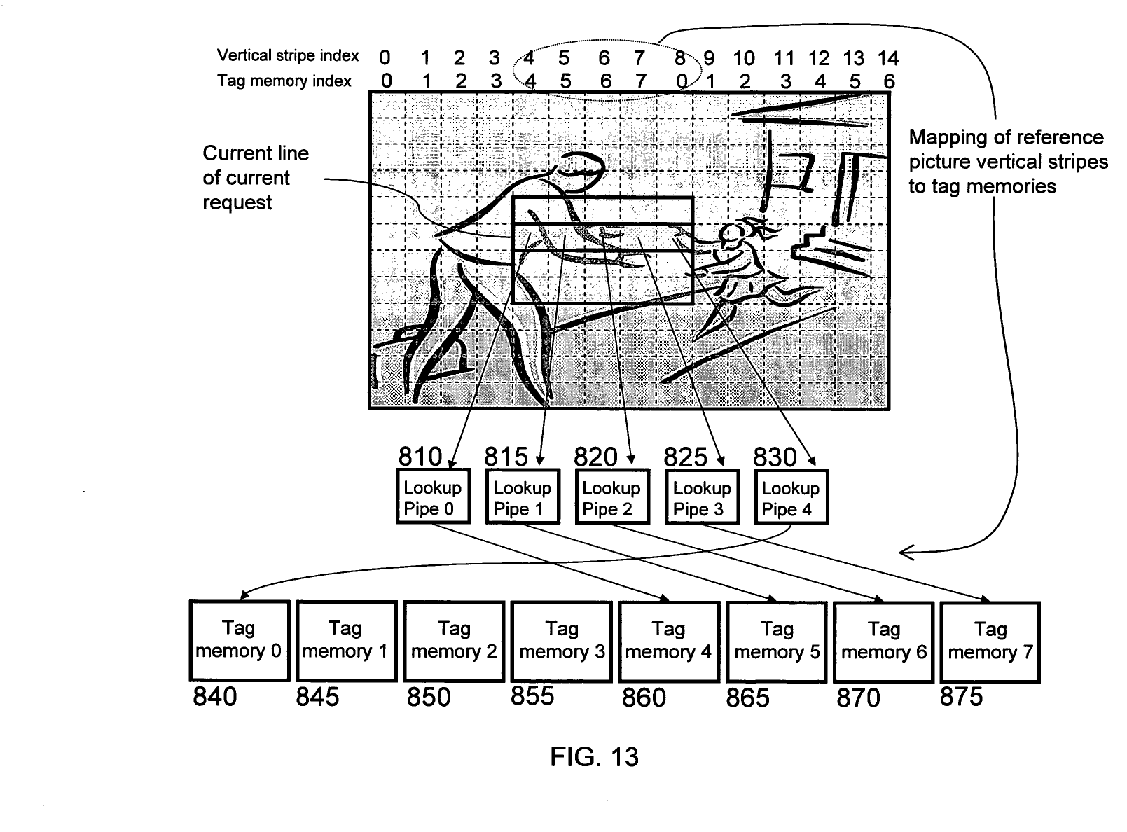

Reference is now made to FIG. 13, which shows the lookup engine in detail. Each sub-cache is assigned a tag memory, and each of the lookup pipes (five in the illustrated exemplary embodiment) 810, 815, 820, 825 and 830 is dynamically mapped to a particular tag memory 840, 845, 850, 855, 860, 865, 870 and 875 based on the horizontal alignment of the client request in the periodic eight (per this embodiment) vertical stripes configuration.

The lookup pipes use MCB operation W3, update_state_row_lookup for initialization of the lookup procedure, and then construct the virtual address of each of the blocks in the horizontal line, map them using the shuffling network 410, and divide them into physical address and tag as described earlier in FIG. 9. The block addresses are read simultaneously from corresponding tag memories, each from its own sub-cache, containing the four associativities tag MSB bits in the same line, as well as a present status, and an indicator of which associativity was last brought into the cache for that particular physical block number. In the embodiment discussed here, with five lookup pipes and five tag memories, and a 4-way associative cache, the 20 (5*4) tags read from the tag memories are compared simultaneously against the 5 tags calculated by the mapping circuit using 20 parallel comparator circuits. Thus, for each of the current five blocks, it is determined whether the block already exists in the cache or needs to be brought from external storage. In the case where a block is already present in the cache, the corresponding MCBE is marked in the MCB as HIT. In the case where a block is not present in the cache, it will be marked either as MISS, or LOADING.

When two active requests are for areas that overlap in the virtual address space, MCBEs in two planes are associated with the overlapping cache blocks. The first time a missing cache block is encountered, the MCBE associated with that encountered cache block is assigned a MISS state. The miss state is determined by checking the tag memories. If the tag memory indicates that the block is missing from the cache, the MCBE is assigned to MISS and the tag memory is updated to TAG_HIT (as distinguished from the MCBE HIT state).

When a subsequent MCBE is encountered and references (i.e., is associated with) the same cache block (whose MCBE was previously marked MISS), the lookup engine determines from the tag memory that the desired cache block has already been encountered. The MCB cube operation R6, lookup_hit_loading is used to determine if the block is actually in the cache (i.e., the MCBE state is HIT) or if the block is still in transit (i.e., the MCBE state is MISS or LOADING for at least one other co-existing MCBE). If the block is not yet actually present in the cache, that subsequent MCBE will be marked LOADING, which indicates that the block is, or soon will be, in transit from the storage backend into the cache, due to an earlier encountered MCBE associated with the same cache block already being marked MISS.

It should be noted that in this embodiment a rare case could potentially cause a deadlock when R6 and W5 are executed in the same cycle. The rare case occurs when an incoming block from another request has just arrived in this cycle and the lookup engine 530 is trying to read the state of MCBEs associated with a current cache block just as the backend data acceptor 550 is updating all MCBEs associated with that cache block to the HIT state. To prevent this deadlock, the storage acceptor block has a bypass logic connected directly to the lookup pipe which detects this case by checking whether the current cache block has just, in this cycle, been brought into the cache, and then modifies the current cache block's MCBE to HIT regardless of R6 saying otherwise.

Cache block replacement is implemented in this preferred embodiment using a least-recently-fetched (LRF) policy. To select a suitable candidate to be replaced out of the available associativities, each candidate is checked via its tag whether it is present, and MCB cube operation R5, tag_usage, is invoked to find out whether any of the currently active requests being handled by the cache is using that particular candidate. If so, that candidate is rejected from consideration. Then, the best candidate is chosen, taking into account the indicator of which block was last brought into the cache, so that older blocks will be replaced first.

The above operations are performed in a pipelined fashion, with a new line of blocks handled at each clock cycle. Lookup starts on a particular line even before the previous line has completed its lookup.

It should be noted that in embodiments where N_{active}<=Nₐ, there is always an associativity available, provided the shuffling network has not been programmed to map multiple blocks in one request to the same physical address. In embodiments where these conditions are not met, cache block replacement may have to wait until an associativity is freed.

To reiterate, the present embodiments permit multiple lines within the same active request, and blocks within the same line are guaranteed not to contend in the cache, enabling the lookup pipe to proceed with no risk of stalling due to collisions or resource contention. This is ensured, for example by sub-dividing the overall cache structure into eight banks (sub-caches) that divide the horizontal address space into eight independent vertical stripes (repeated periodically), and by designing the hash mapping function used by the shuffling network such that adjacent vertical blocks in the virtual address space map into different physical addresses.

Moreover, in some embodiments, lookup on different active requests can proceed in parallel. As long as the number of active requests N_{active} (four in the current example) is less than or equal to the associativity (4-way in the current example), it is ensured that each particular physical address is not used more than N_{active} (4) times, again allowing the lookup pipes to operate without the possibility of having to wait for cache memory to become available for replacement.

Other embodiments of the invention are possible where the above-stated condition does not hold (i.e., N_{active}>Nₐ). For example the embodiment may provide a larger number of active requests (for example, 8), while avoiding higher associativity settings (e.g., using 4-way associativity). In that case, a resulting collision can be handled by adding a WAIT state to each cache block's MCBE. The WAIT state may be used in the case where a miss is detected, but no associativity is available for replacement. The presently described embodiment then waits until such a cache block exits the cache on its way to the client (i.e., satisfying all active requests for it), freeing the corresponding associativity. The freed associativity is then used for a cache block waiting for it as indicated by the WAIT state.

Returning to FIG. 10, as mentioned earlier, the cache architecture can be viewed as an overall system comprising several subsystems held together by the MCB. The lookup subsystem task, described in the previous paragraph, can be viewed as populating the MCB planes with the block state of each MCBE, being HIT, MISS, or LOADING. The next subsystem is the backend storage miss logic, 540. Subsystem 540 continuously monitors the MCB for new blocks pending with a MISS state. When subsystem 540 finds such a block, it initiates the transfer of data of that block from the external frame storage into the cache by providing a request to the storage backend controller module 110 (545). Typically, subsystem 110 (545) can support a maximum number of simultaneous requests, and therefore the miss logic 540 waits until a free storage request slot is available before scheduling a miss request.

When several miss candidates are simultaneously contending for service, an arbiter is used to select the best candidate, taking into account which active request is the oldest, and for a particular request, scans the blocks in the request in a raster scan fashion. By fetching the blocks in raster scan fashion, the lines tend to become available to the client in top-to-bottom order.

The miss logic is internally pipelined as well, being able to schedule a new memory block request every cycle, at a rate faster than the rate at which the backend memory is able to service the requests. Due to this, blocks that miss and are close in the picture are requested in close proximity in time, and since they are typically stored in the memory storage close to each other, memory bank switch activation penalty (e.g., as in DDR) will be minimized. Each such request to the memory is also classified with a priority indicator, which can be lowered if necessary, to prevent overwhelming the memory storage with too many requests in case this is an issue.

In parallel to the miss logic subsystem 540 issuing new requests to the backend module 110 (545), the backend module services the requests, and returns block data through the storage data acceptor subsystem 550. For each returned block, the acceptor module changes the returned block's state from MISS to HIT in the MCB. Due to the parallel processing of several active requests, when there is region overlap it may happen that several active requests wait for a particular block to arrive. As described in the lookup subsystem, only the first such block has MISS state and causes a request to the storage backend module, while subsequent requested physical blocks mapped to the same virtual block are assigned the LOADING state and partake of that request. However, all waiting requests need to be notified of block completion, which is done using MCB cube operation W5, update_hit.

The backend data acceptor subsystem 550 writes the returned data into the main data cache memories. In a preferred embodiment of the invention, the cache is divided into eight sub-caches, or banks, corresponding to the repeating eight vertical stripes division of the input frames as described above with reference to FIG. 5 and FIG. 8. Reading from the cache memory subsystem while simultaneously writing is supported in this embodiment as described in the discussion for FIG. 3.

In a preferred embodiment, a block corresponds to 256 bits (8 columns×4 rows×8 bits per pixel) and is returned from the external storage in 2 clock cycles, 128 bits in each cycle—the first cycle returning rows 0 and 1, and the second cycle rows 2 and 3. Additionally, each memory bank is further divided to two sub-banks, each 64 bit wide, and data is written into the memory in the first cycle in direct fashion—(0,1), but in reversed order in the second cycle—(3,2), so that lines 0 and 3 (or 1 and 2) share the same memory. The allows the transfer logic to read two lines simultaneously when transferring data to client both in the frame format, in which case lines (0+1) and (2+3) need to be simultaneously transferred, and also in field formats, where lines (0+2) or (1+3) are simultaneously transferred.

In parallel to the data acceptor module updating the data memories and the MCB, the client transfer module transfers available data from the cache to the client. The first stage of the transfer module is an arbiter, selecting the active request to be handled. For each handled request, data is transferred to the client two lines at a time. The internal cache division to 8 sub-caches spanning 64 horizontal pixels, and the fact the horizontal request size (including aligning to cache blocks grid) is guaranteed to be smaller than the horizontal span, per the preferred embodiment, guarantees that data for the entire line will be present simultaneously, and can be simultaneously read from the single port data memories in a single clock cycle. The additional sub-division of each bank to two sub-banks, and the reverse order of the lines in each elemental block, guarantees that two lines can be simultaneously transferred in a single clock cycle.

The best active request is first chosen by using MCB operation R2, line_hit, for all active requests to filter out the requests that already have their current line data available in the cache. Then the remaining list is filtered against on-going write commands to the same memory banks that have to be read from, as explained earlier in the data acceptor module. Finally, similar to the miss logic, the best candidate out of the remaining list is chosen by taking into account the arrival time of the active requests from the client, i.e., giving priority to the oldest active request.

Once the best candidate is chosen, one or two lines of data are read from the data memories. In some embodiments, the data is transferred directly back to the client, along with the indication of which request number it corresponds to (request id), and which line it is from the request.

In another embodiment, the data is first passed through luma/chroma output pooling units that are placed between the client transfer module and the client. The luma/chroma pooling units serve two purposes. One purpose is to reorder the active request lines so that each request can be transferred to the client in its entirety at a fixed rate once all lines have been gathered, in case the client cannot handle the inter-mixing of lines from various requests. The second purpose is to allow the client to postpone the data transfer to it in case it is not able to handle the bandwidth due to its own limitations. For that purpose, a STALL signal is issued by the client to the cache per pooling unit, causing the data transfer from the pooling unit to the client to stop immediately. Meanwhile, the requests that are still being worked on in the client transfer logic pipeline can be buffered by draining into the pooling units. The client transfer logic would then assess the state (i.e., capacity utilization) of the pooling units before it selects new active requests to work on. Similarly, the activation block 520 may consider the utilization of the output pooling units in order to give priority to an output pooling units that is less full than other output pooling units. Also similarly, the output pooling units' output logic 570 and 580 may give priority to units that are more full so as to free space.

In a preferred embodiment shown in FIG. 10, the output pooling units may be designed as circular buffers each implementing a FIFO queue. In the presently described embodiment, there is one FIFO queue for each plane in the MCB. In other embodiments, there may be multiple pooling units. For example, when used for video image processing, it may be useful to distinguish between luminance output and chrominance output. In some embodiments, the part of a requesting processor that handles one type of output (luma or chroma) may accept output data at a different rate than the other type of output. An entry is allocated in the queue for each active request, each active request being assigned to one plane in the MCB as described above. Each entry in the queue is allocated to be of a size sufficient to hold the results of the corresponding request. After a row of a request arrives at the cache, the row is transferred to the appropriate location within the corresponding entry of a queue by the client transfer logic 560. The rows may arrive in arbitrary order. This process continues until all the rows have been placed in the entry. At that point the request is completed, vis-à-vis the MCB and related cache logic, thus freeing the associated MCB plane. The MCB plane is then available for a subsequent request, the output of which will be placed in the queue in a newly allocated entry.

Meanwhile, the queue's output logic (570 or 580) transfers a completed entry from the head of the queue to the client. After transfer, the space allocated for the entry is freed for re-use in the circular queue.

As an additional feature of a preferred embodiment, each output pooling unit may be divided into two sub-unit, one sub-unit for even request lines, and one sub-unit for odd request lines. By dividing into two sub-units, two lines may be written simultaneously, one to each sub-unit.

To illustrate how the output pooling units work, consider the following simplified exemplary embodiment. Each output pooling unit has a write address (WA) and read address (RA). Data is written into the unit by the transfer logic 560 a line (or two) at a time (possibly not in order as described above) such that line i is written to address WA+i (with appropriate logic to map lines to the even or odd sub-unit, as described above). At each cycle the line offset i, may change. When all the lines of a particular active request have been written to the entry, the write address WA is incremented by the request size, effectively starting a new entry.

From the output logic 570 and 580 side, read access is performed in a strictly sequential manner, reading the data 1 or 2 lines at a time and incrementing the read address RA after each read.

For the benefit of clarity, we have described various embodiments of the present invention in the context of a typical use for motion estimation. After considering the description, those skilled in the art will realize that in addition to the detailed examples described, the present invention can be used in different configurations of the various parameters (such as bₓ, b_{y}, N_{banks}, etc), as well as in many other video and image processing applications or other computing applications unrelated to image processing that could benefit from reduction in the access times to memory. Examples of some other applications that require high memory bandwidth during processing of motion pictures or images are: video image enhancement, video pre-processing, robotic vision, pattern matching, image recognition, and display processing, or any other process that requires repeated access to many pixels.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A cache memory device for use in an image or motion picture processing system, said cache memory device being located between a main memory and a requesting processor, the main memory storing images, said images having an image width and an image height, said images being divisible into blocks, each block having a block width and a block height being less than or equal to the image width and image height respectively, the cache memory device being configured so as to temporarily locate arbitrary ones of said blocks in said cache memory device thereby to improve retrieval performance.

2. A device as claimed in claim 1 configured to receive requests from a requesting processor, said requests comprising clustered combinations of the blocks, thereby to permit the requesting processor to operate on a cluster of contiguous blocks, said cluster being of a shape defined by the requesting processor.

3. A device as claimed in claim 2 wherein the requesting processor is configured to operate on one or more clusters, where each said cluster comes from an arbitrary image in the main memory.

4. A device as claimed in claim 2 wherein the requesting processor is a motion vector selection circuit as part of a motion estimation system.

5. A device as claimed in claim 4 wherein said motion vector selection circuit defines a cluster shape to correspond to a portion of an image.

6. A cache memory device for use in image or motion picture processing systems, said cache memory device being located between a main memory and a requesting processor, the main memory storing images, each image having an image width and an image height, each said image being divisible into blocks, each block having a block width and a block height being less than or equal to the image width and image height respectively, the requesting processor being configured to issue requests to the cache memory device for arbitrary portions of an image stored in the main memory, said requests having a request width and request height less than the image width and image height respectively, the cache memory device being configured so as to temporarily locate arbitrary ones of said blocks in said cache memory device to improve retrieval performance, and the cache memory device comprising a cache logic circuit engine able to service multiple requests from the requesting processor simultaneously.

7. A device as claimed in claim 6 wherein the request width and request height are at least as large as the block width and block height respectively.

8. A device as claimed in claim 6 wherein the logic circuit engine comprises
a cache memory that stores the sub-blocks; and
a request unit, by which the cache memory device receives requests from a requesting processor, the requests being for a portion of the main memory; and
a main memory backend interface unit by which data is transferred from the main memory into the cache memory at a first data transfer rate; and
a client data transfer interface unit, by which the cache provides requested sub-blocks to the requesting processor at a second data transfer rate,
wherein the request unit, the main memory backend interface unit, and the client data transfer interface unit are configured to work independently and in parallel with each other.

9. A device as claimed in claim 8 wherein the second data transfer rate is higher than the first data transfer rate.

10. A device as claimed in claim 6 wherein the requesting processor's request is for an arbitrary pixel-aligned portion of an image and the portion corresponds to and is contained within a subset of a grid of the image's blocks, said subset of the grid containing the entire requested portion and said subset of the grid grid comprising one or more rows of blocks and one or more columns of blocks, and the cache memory device comprises a pipelined processing unit to operate on the request, said processing unit being pipelined such that each successive element in the pipeline operates in parallel on different rows of the grid in a pipelined fashion.

11. A device as claimed in claim 10 wherein each pipelined processing unit operates on a single column of the grid.

12. A device as claimed in claim 11 wherein each pipelined processing unit is configured to be associated with a tag memory said tag memory configured to hold a hit/miss status and a virtual address of a block stored in the cache.

13. A device as claimed in claim 11 comprising a number M of pipelined processing units, where M is as large as the maximum grid width.

14. A cache memory device for location between a main memory and a requesting processor, the main memory storing memory blocks, some of which are temporarily located in said cache memory device to improve retrieval performance, said cache memory device configured to receive requests for respective ones of said memory blocks, said cache memory device comprising:
an input pooling unit for pooling incoming requests for blocks of memory; and
a request selection and servicing mechanism configured for selecting amongst and servicing requests in said pool for memory block retrieval, said selecting and servicing being according to a first optimization criterion, thereby to optimize operation of said cache.

15. A device as claimed in claim 14 wherein the first optimization criterion comprises consideration of the presence or absence in the cache of all or a portion of the requested memory block.

16. A device as claimed in claim 14 wherein the first optimization criterion comprises consideration of an age of a given request.

17. A device as claimed in claim 14 wherein the first optimization criterion comprises consideration of overlapping memory requests.

18. A device as claimed in claim 14 wherein the first optimization criterion comprises consideration of the location of the requested memory block within the main memory.

19. A device as claimed in claim 18 wherein the first optimization criterion comprises assigning a higher priority to retrieval of adjacent memory blocks in the main memory.

20. A device as claimed in claim 14 wherein the first optimization criterion comprises consideration of the location of requested memory within the cache memory.

21. A device as claimed in claim 14 wherein the first optimization criterion comprises consideration of a concurrent write operation taking place to the cache memory from the main memory.

22. A device as claimed in claim 14, further comprising an output pooling unit for pooling memory blocks for transmission to the requesting processor.

23. A device as claimed in claim 22 wherein the output pooling unit comprises a plurality of pooling sub-units, each sub-unit accumulating interim results for a request.

24. A device as claimed in claim 23 further comprising an output selection mechanism for selecting a memory block from a sub-unit for transmitting to the requesting processor, said selecting depending on a second optimization criterion, thereby to optimize operation of said output pooling unit.

25. A device as claimed in claim 24 wherein the second optimization criterion comprises consideration of respective capacity utilization of the sub-units.

26. A device as claimed in claim 24 wherein the second optimization criterion comprises consideration of a desired order of interim results for the respective requests, thereby transmitting results in a desired order.

27. A device as claimed in claim 24, wherein the first optimization criterion comprises consideration of availability of space in the pooling sub-units.

28. A method for storing and delivering memory blocks from a memory storage device to a client processor requesting said memory blocks, said memory storage comprising a plurality of independently accessible memory banks, said memory blocks being of a given width and height such that the height comprises one or more successive groups of four rows, each said group having a first, second, third, and fourth row, successively; the method comprising storing the rows within each said group such that the first and fourth rows are stored in one of said plurality of memory banks, and the second and third rows are stored in another of said plurality of memory banks, thereby permitting concurrent transmission of data from any one of the following combinations of rows:
First row and second row, or
Third row and fourth row, or
First row and third row, or
Second row and fourth row.

29. A method as claimed in claim 28 wherein the first and fourth rows are stored in respectively different memory banks.

30. A method as claimed in claim 28 wherein the second and third rows are stored in respectively different memory banks

31. A method as claimed in claim 28 wherein the memory blocks represent portions of a full frame video image and the client processor memory requests are for portions of the full frame video image.

32. A method as claimed in claim 28 wherein the memory blocks represent portions of a full frame video image, wherein the frame comprises an odd field and an even field, and the client processor memory requests are for portions of an odd field of the full frame video image.

33. A method as claimed in claim 28 where the memory blocks represent portions of a full frame video image, wherein the frame comprises an odd field and an even field, and the client processor memory requests are for portions of an even field of the full frame video image.

34. A cache memory device for location between a main memory and a requesting processor, the main memory storing memory blocks, some of which are temporarily located in said cache memory device to improve retrieval performance, and comprising a plurality of single-port cache memory components for storing respective memory blocks, said cache memory device configured with a controller to select memory blocks for transmission from said cache memory device to the requesting processor according to a first criterion, the first criterion being that writing of data is permitted to a first of said memory components and reading of data simultaneously with said writing is permitted from at least one other of said memory components.

35. The device of claim 34, wherein said first criterion is further that simultaneous reading of data is permitted from a plurality of other memory components.

36. The device of claim 35, wherein the main memory is configured to store one or more images, each image having an associated width W_{image} and height H_{image} and where the requesting processor issues requests for portions of said images, each such request having a width W_{request} and height H_{request}, where W_{request}≦W_{image} and H_{request}≦H_{image}.

37. The device of claim 36 where the images are from a motion picture stream.

38. A cache memory device for location between a main memory and a requesting processor, the main memory storing memory blocks, some of which are temporarily located in said cache memory device to improve retrieval performance, said cache memory device configured to receive requests for respective ones of said memory blocks, said cache memory device comprising a content-addressable memory structure for maintaining the state of the cache memory and the relationship between the main memory's address space and the cache memory's address space.

39. A device as claimed in claim 38 further comprising a unit for accepting the requests.

40. A device as claimed in claim 38 further comprising a unit for activating the requests.

41. A device as claimed in claim 38 further comprising a unit for detecting cache misses.

42. A device as claimed in claim 38 further comprising a main memory backend interface unit by which data is transferred from the main memory into the cache memory device.

43. A device as claimed in claim 38 further comprising a client data transfer interface unit, by which the cache provides requested sub-blocks to the requesting processor.

44. A device as claimed in claim 38 wherein the content-addressable memory structure comprises a plurality of elements, each said element maintaining the state of a portion of the cache memory and the relationship between the main memory's address space and the cache memory's address space for said portion.

45. A device as claimed in claim 44 wherein the main memory is configured to store one or more images, each image having an image width and an image height, and wherein the requesting processor requests portions of an image, each requested portion having a request width and a request height and the content-addressable memory structure comprises a plane having the elements and said plane is a given number of elements wide and a given number of elements high.

46. A device as claimed in claim 45 wherein the content-addressable memory structure comprises a plurality of said planes, each plane comprising a given width and height.

47. A device as claimed in claim 46 wherein each of the planes is assignable to correspond to one of a plurality of memory requests.

48. A device as claimed in claim 38 wherein the content-addressable memory structure comprises a three-dimensional structure of state elements arranged as a plurality of two-dimensional planes.

49. The device of claim 48 configured to support a write operation to all the elements in a plane.

50. The device of claim 48 configured to support a write operation to all the elements in a single row of a single plane.

51. The device of claim 48 configured to support a write operation to a single element in a single row of a single plane.

52. The device of claim 48 configured to support a write operation to all the elements in the cube matching a particular criterion.

53. The device of claim 48 configured to support a read operation from all the elements in a plane.

54. The device of claim 48 configured to support a read operation from all the elements in a row of a plane.

55. The device of claim 48 configured to support a read operation from a single element in a single row of a single plane.

56. The device of claim 48 configured to support a read operation from all the elements in the cube matching a particular criterion.

57. A cache memory device for location between a main memory configured to store an image of a given width W_{image} and height and a requesting processor, the image comprising memory blocks, some of which are temporarily located in said cache memory device to improve retrieval performance, said cache memory device configured to receive requests for respective ones of said memory blocks, said cache memory device comprising a plurality of J sub-caches, each sub-cache comprising cache blocks of a given width W_{cache-block} and height, said W_{cache-block} being less than W_{image}, and the image being logically divided into groups of J vertical stripes, each said vertical stripe being of width W_{cache-block}, and each sub-cache being associated with exactly one vertical stripe of each group of J vertical stripes.

58. A device as claimed in claim 57, wherein each sub-cache is divided into a plurality of sub-sub-caches.

59. A device as claimed in claim 58 wherein each sub-sub-cache is configured for storing of data.

60. A device as claimed in claim 57 further comprising a programmable multiplexer shuffling network to permute addresses of memory blocks stored in the cache memory, thereby adjusting the mapping from main memory address space to the cache memory address space according to a first criterion.

61. A device as claimed in claim 60 where the first criterion comprises a requirement to map adjacent main memory blocks to different physical cache memories.

62. A device as claimed in claim 57 wherein a stored image further comprises an identifier and each image further comprises two color parts, a first color part representing the image chrominance and a second color part representing the image luminance, and the requesting processor's request comprises a specification, said specification comprising an image identifier I, an image color part C, a horizontal coordinate of the request Rₓ, and a vertical coordinate of the request R_{y}, and said device further comprising a mapping unit to map the request specification to a scalar address within the cache device according to a second criterion.

63. A device as claimed in claim 62 wherein the second criterion comprises a concatenation of one or more of the specification's components or portions thereof.

64. A device as claimed in claim 57 wherein the cache device further comprises a mapping unit to map each vertical stripe to the stripe's associated sub-cache and wherein J is a power of two and the mapping unit is configured to map the stripes according to Rₓ modulo J.

65. A device as claimed in claim 62 further comprising a programmable multiplexer shuffling network to permute addresses of memory blocks stored in the cache memory, thereby adjusting the mapping according to a third criterion.

66. A device as claimed in claim 65 wherein the device is configured such that the third criterion comprises a bitwise permutation involving bits from I, C, R_{y}, and Rₓ.

67. A device as claimed in claim 65 wherein J is a power of two and wherein the device is configured such that the third criterion comprises a bitwise permutation involving I, C, R_{y}, and Rₓ/J.
